(19) United States
(12) Patent Application Publication
(10) Pub. No.: US 2025/0284077 A1
(43) Pub. Date: Sep. 11, 2025

(54) DEMOUNTABLE COUPLING OF OPTICAL CONNECTOR AND OPTOELECTRONIC DEVICE

(71) Applicant: Senko Advanced Components, Inc., Hudson, MA (US)

(72) Inventors: Robert Ryan VALLANCE, Newbury Park, CA (US); Yang CHEN, Thousand Oaks, CA (US)

(21) Appl. No.: 19/077,045

(22) Filed: Mar. 11, 2025

Related U.S. Application Data
(60) Provisional application No. 63/563,927, filed on Mar. 11, 2024.
(60) Provisional application No. 63/570,198, filed on Mar. 26, 2024.

(51) Int. Cl. G02B 6/42

(52) U.S. Cl. CPC G02B 6/4278; G02B 6/4228

(57) ABSTRACT

Optical alignment of a receptacle at an aligned position on an optoelectronic device body is accomplished using an alignment optical connector that is demountably attached to the receptacle by matching passive alignment features on the facing surfaces between the receptacle and the alignment optical connector. The device body includes a first row of at least two data optical ports, and a second row of alignment input and output ports parallel to and spaced from the first row of data optical ports by a parallel spacing. The data optical ports communicate with the optoelectronic device. The alignment ports correspond to a loopback waveguide. The aligned position of the receptacle is determined from the loopback waveguide. The receptacle is permanently attached to the device body at this aligned position. A data optical connector is similarly configured as the alignment optical connector, in the manner in which optical fibers are supported to input/output optical signals and with similar passive alignment features, but the passive alignment features are referenced to the optical fibers by an offset equivalent to the parallel spacing between the first and second rows. The second row is same or shorter than the first row. The number of data optical ports is greater or equal to the number of alignment optical ports. The data optical ports and the alignment optical ports are arranged in a 2×N matrix.

### PRIORITY CLAIM

This application claims the priority of: (a) U.S. Provisional Patent Application No. 63/563,927 filed on Mar. 11, 2024; and (b) U.S. Provisional Patent Application No. 63/570,198 filed on Mar. 26, 2024. These applications are fully incorporated by reference as if fully set forth herein. All publications noted below are fully incorporated by reference as if fully set forth herein.

### BACKGROUND OF THE INVENTION

### 1. Field of the Invention

The present invention relates to coupling of light into and out of optoelectronic devices (e.g., photonic integrated circuits (PICs), laser arrays, photodiode arrays, etc.), and in particular demountable couplings based on passive alignment between optical connectors and optoelectronic devices.

### 2. Description of Related Art

Photonic integrated circuits (PICs) or integrated optical circuits are part of an emerging technology that uses light as a means of communication, computing, or sensing as opposed to an electric current. A PIC integrates multiple (at least two) photonic functions and as such is analogous to an electronic integrated circuit. The major difference between the two is that a photonic integrated circuit provides functionality for information signals on optical wavelengths typically in the visible spectrum or near infrared 850 nm-1650 nm.

PICs are used for various applications in telecommunications, instrumentation, sensing, and signal-processing fields. A PIC may be made using various material platform such as silicon (Si), silicon nitride (SiN), indium phosphide (InP). The PIC, regardless of material, typically uses optical waveguides to route optical signals throughout the PIC and/or to interconnect various elements, such as optical switches, couplers, routers, splitters, multiplexers/demultiplexers, modulators, amplifiers, wavelength converters, optical-to-electrical (O/E) (e.g. photodiodes) and electrical-to-optical (E/O) converters (e.g. lasers), etc. A waveguide in a PIC device is usually an on-PIC solid light conductor that guides light due to an index-of-refraction difference between the waveguide's core material and cladding material.

For proper operation, a PIC needs to efficiently couple light signals between an external optical fiber and one or more of on-chip waveguides. An advantage of using light as a basis of circuit operation in a PIC is that its energy cost for high-speed signal transmission is substantially less than that of electronic chips, thus efficient signal transmission between PIC devices and other optical devices, such as optical fibers, that maintains this advantage is an important aspect of PICs.

Most PICs require single-mode optical connections that require stringent alignment tolerances between optical fibers and the PIC, typically less than 1 micrometer. Efficient optical coupling to and from the on-chip waveguides to an external optical fiber is challenging due to the mismatch in size between the single-mode waveguides and the light-guiding cores within single-mode optical fibers. For example, the dimension of a typical silica optical fiber is approximately forty times larger than a typical waveguide on a PIC. Because of this size mismatch, if the single mode waveguide and the optical fiber are directly coupled, the respective modes of the waveguide and optical fiber will not be coupled efficiently resulting in an unacceptable insertion loss (e.g., >10 dB).

One approach to coupling optical fibers to a PIC device (or a PIC chip package) is to attach an optical fiber array to the edge of the PIC chip. Heretofore, optical fiber arrays are aligned to elements on the PICs using an active alignment approach in which the position and orientation of the optical fiber(s) is adjusted by machinery until the amount of light transferred between the fiber and PIC is maximized. This is a time-consuming process that is generally done after the PIC is diced from the wafer and mounted within a package. This postpones the fiber-optic connection to the end of the production process. Once the connection is made, it is permanent, and would not be demountable, separable or detachable without likely destroying the integrity of connection for any hope of remounting the optical fiber array to the PIC. In other words, the optical fiber array is not removably attached to the PIC, and the fiber array connection, and separation would be destructive and not reversible (i.e., not reconnectable).

It would be advantageous if the fiber-optic connections could be created prior to dicing the discrete PICs from the wafer; this is often referred to as wafer-level attachment. Manufacturers of integrated circuits and PICs often have expensive capital equipment capable of sub-micron alignment (e.g., wafer probers and handlers for testing integrated circuits), whereas companies that package chips generally have less capable machinery (typically several micron alignment tolerances which is not adequate for single-mode devices). However, it is impractical to permanently attach optical fibers to PICs prior to dicing since the optical fibers would become tangled, would be in the way during the dicing operations and packaging procedures, and are practically impossible to manage when the PICs are pick-and-placed onto printed circuit boards and then soldered to the PCBs at high temperatures.

US Patent Publication No. 2016/0161686A1 (commonly assigned to the assignee of the present application and fully incorporated by reference herein) discloses passive alignment based demountable optical connectors for optoelectronic devices. Further, U.S. Pat. No. 11,500,166 (commonly assigned to the assignee of the present application and fully incorporated by reference herein) further discloses specific embodiments of passive optical alignment couplings based on elastic averaging. As its principles are known in the prior art, elastic averaging represents a subset of surface coupling types where improved accuracy is derived from the averaging of errors over a large number of contacting surfaces. Contrary to kinematic design, elastic averaging is based on significantly over-constraining the solid bodies with a large number of relatively compliant members. As the system is preloaded, the elastic properties of the material allow for the size and position error of each individual contact feature to be averaged out over the sum of contact features throughout the solid body. Although the repeatability obtained through elastic averaging may not be as high as in deterministic kinematically coupled systems, elastic averaging design allows for higher stiffness and lower local stress when compared to kinematic couplings. More importantly, elastic averaging provides for accurate coupling with lower manufacturing tolerances on the contacting surfaces. In a well-designed and preloaded elastic averaging coupling, the accuracy is approximately inversely proportional to the square root of the number of contact points.

US Patent Publication No. 2024/0027703A1 (commonly assigned to the assignee of the present application and fully incorporated by reference herein) discloses a demountable connection of an optical connector to an optoelectronic device using a foundation having features for integrated optical coupling and demountable coupling. The foundation provides for demountable passive alignment connection to an optical connector. The foundation is permanently attached and aligned to a PIC chip. The foundation also includes passive alignment features that match the passive alignment features on the facing side of the optical connector. US Patent Publication No. 2024/0085633A1 (commonly assigned to the assignee of the present application and fully incorporated by reference herein) further discloses a configurable optical multi-connector module implementing demountable coupling based on elastic averaging.

US Patent Publication No. 2024/0142722A1 (commonly assigned to the assignee of the present application and fully incorporated by reference herein) discloses further embodiments of elastic averaging alignment features that are well suited for passive optical alignment coupling between optical connectors and optoelectronic devices.

What is needed is an improved deployment of passively aligned demountable optical couplings for optoelectronic devices, which facilitates testing optical connections, and/or functional testing of optoelectronic devices in the manufacturing process, which would result in improved tolerance, manufacturability, ease of use, functionality and reliability at reduced costs for optical connections to optoelectronic devices.

### SUMMARY OF THE INVENTION

The present invention provides an improved deployment of passively aligned demountable optical couplings for optoelectronic devices, which facilitates optical testing for coupling between fibers and PICs, and/or functional testing of optoelectronic devices during the manufacturing process, to achieve improved tolerance, manufacturability, ease of use, functionality and reliability at reduced costs for optical connections to optoelectronic devices.

In the context of the present invention, optical alignment involves positioning of an optical connector relative to the optoelectronic device, to align the optical axis of the respective optical elements (e.g., structured reflective surfaces) and/or components (e.g., optical fibers) of the optical connector to the optical axis of the corresponding optical elements or components of the optoelectronic device, so as to minimize optical signal attenuations or insertion losses between the optoelectronic device and optical connector to within acceptable tolerance.

The present invention will be explained in connection with the illustrated embodiments. As an introduction of the present invention, for demountable coupling to an optoelectronic device, an optical connector (e.g., supporting or as a part of an optical bench that supports an optical fiber) is configured and structured to be non-destructively, removably attachable for reconnection to a complementary/matching receptacle (i.e., akin to a socket for the optical connector) in passive alignment therewith. The receptacle may be attached to a device body of the optoelectronic device which may be an integral part of the optoelectronic device (e.g., part of a photonic integrated circuit (PIC)), or which may be a separate component positioned in alignment with and coupled or attached to the opto-electronic device, e.g., on a printed circuit board (PCB) or a structural component attached to the optoelectronic device. The receptacle is positioned in optical alignment with electro-optical elements (e.g., grating couplers, lens arrays, spot-converters, edge-emitting waveguides, etc.) associated with the optoelectronic device. The receptacle needs to be precisely and accurately positioned with respect to the optical input/output ports in the optoelectronic device to provide a precise reference for passive alignment to the external optical connector. The optical connector can be removably attached to the receptacle by passive alignment, via a ‘separable’ or ‘demountable’ or ‘detachable’ action that accurately optically aligns the optical components/elements in the optical connector to the optoelectronic device along a desired optical path. To maintain optical alignment cycles of connect-and-disconnect-and-reconnect, the optical connector needs to be precisely and accurately aligned passively to the receptacle. The optical connector and receptacle are aligned with one another using passive mechanical alignment features constructed from geometric features on the two bodies, which may be based on kinematic alignment, quasi kinematic alignment, or elastic averaging alignment. With the foregoing as introduction, the present invention may be summarized below.

In accordance with the present invention, optical alignment of the receptacle on the device body in reference to the optoelectronic device is achieved using an alignment optical connector demountably attached to the receptacle based on complementary/matching passive alignment features on the facing surfaces between the receptacle and the alignment optical connector, and an optical source and an optical detector, external and functionally coupled to the alignment optical connector, providing to and receiving from the alignment optical connector an alignment optical signal transmitted in loopback waveguide(s) in the device body associated with the optoelectronic device. The inventive system and method implementing a passive alignment demountable coupling for an optical connector can achieve sub-micrometer optical alignment between the optical connector and the optoelectronic device, by using the optical detector to measure the optical power of an optical alignment signal provided by the optical source after propagating through the loopback passive waveguide in the device body. The position and orientation that maximizes the optical power (optimum location) is the desired or targeted optically aligned position of the alignment optical connector and the device body, establishing the optically aligned position of the receptacle with respect to the device body. Once the receptacle is permanently attached to the device body at this aligned position, a data optical connector for regular/normal active operation with the optoelectronic device, which has similar passive alignment features facing the receptacle, can be demountably coupled to the receptacle by passive alignment of the optical connectors and the receptacle.

In one embodiment, the device body (e.g., a housing of the optoelectronic device, an interposer, optical engine, etc.) associated with the optoelectronic device, comprises a first linear array of at least two active data optical ports (e.g., active input/output (I/O) ports with grating couplers or lenses) arranged in a first row, and a second linear array of at least a pair of alignment optical ports (e.g., grating couplers or lenses) including an alignment input port and an alignment output port arranged in a second row parallel to and spaced from the first row of data optical ports by a parallel spacing. The data optical ports transmit light to/from optical data waveguides communicating active photonic structures (e.g. modulators, detectors, resonators, etc.) that process the optical signals within the optoelectronic device. The pair of alignment ports correspond to a loopback optical alignment waveguide at a defined location in relation to data optical ports. In one embodiment, locations of the second linear array/the second row of alignment optical ports do not extend beyond the first linear array/the first row of data optical ports in a parallel direction (i.e., the second row is same or shorter than the first row). In one embodiment, each alignment optical port is adjacent to a data optical port in a direction perpendicular to the first and second rows. In one embodiment, the number of data optical ports is greater than or equal to the number of alignment optical ports (i.e., at most as many alignment optical ports as the data optical ports). In one embodiment, the data optical ports and the alignment optical ports are arranged in a 2×N matrix, where N=number of ports in a row. The passive optical alignment waveguide is disposed outside the active region of the optoelectronic device.

In one embodiment, the alignment optical connector comprises an optical bench subassembly, having optical structured reflective surfaces defined thereon for directing optical signals between the optical connector and the optoelectronic device body. In one embodiment, the optical bench subassembly is in the form of an optical fiber subassembly (OFSA) supporting one or more optical fibers in optical alignment with the structured reflective surfaces (i.e., with the optical axis of the respective optical fibers aligned with the optical axis of the corresponding data reflective surface). In one embodiment, the alignment optical connector has an alignment connector body having grooves supporting alignment input and output optical fibers substantially parallel to the top surface of the device body, wherein the alignment connector body comprises an optical bench supporting the alignment input and output optical fibers, wherein the optical bench comprises a first linear array of structured reflective surfaces defined in reference/relation to the second set of passive alignment features, each optically aligned with the respective alignment input and output optical fibers, and wherein the alignment input and output optical fibers are optically coupled to the alignment input and output ports on the device body via the first array of structured reflective surfaces. A first structured reflective surface directs (i.e., folds, reshapes, collimates, converges and/or focuses) an alignment optical signal from the optical source delivered by the alignment output optical fiber to the alignment input port of the alignment waveguide of the device body, and after the alignment signal has been transmitted from the input port to the output port through the waveguide, a second structure reflective surface directs (i.e., folds, reshapes and/or collimates) the alignment optical signal from the alignment output port of the alignment waveguide to the alignment input optical fiber. By adjusting the relative position and orientation between the optical connector and the optoelectronic device, and detecting and observing the optical power of the alignment signal reflected from the second alignment reflective surface, the location of optimum optical alignment of the alignment optical connector and device body associated with the optoelectronic device can be determined (e.g., at a detected maximum optical power; i.e., at lowest insertion loss or optical signal attenuation). In one embodiment, the structured reflective surfaces are freeform reflective surfaces of the body (e.g., ellipsoidal, concave reflective), reflecting light away from the body.

In one embodiment, the alignment connector body is a unitary body with a bottom surface defined with the second set of passive alignment features. In an alternate embodiment, the alignment connector body comprises a base and a separate cover plate attached to the bottom of the base, wherein an exposed surface of the cover plate (i.e., the bottom surface of the alignment connector body) is defined with the second set of passive alignment features.

In one embodiment, the input and output ports of the alignment waveguide are each defined by a grating coupler, with a first grating coupler receiving the alignment optical signal from the alignment output optical fiber via the first structured reflective surface, and a second grating coupler outputting the alignment optical signal to the alignment input optical fiber via the second structured reflective surface of the optical connector. The linear array of data optical ports are defined by grating couplers associated with the optical data waveguides communicating optical signals to the associate optoelectronic device.

The data optical connector (or the optional test optical connector) comprises a data connector body structure presenting a similar optical path as the alignment connector body, i.e., with a similar optical path defined between the supported optical fibers and the device body, and having a set of passive alignment features on a planar bottom surface, matching/complementary to the set of passive alignment features on the top surface of the receptacle, but with an offset shift in the relative positioning of the passive alignment features with respect to the bottom surface of the connector body by an equivalent to the parallel distance, so as to align the optical fibers to the data optical ports instead of the alignment optical ports. The optical characteristics, including the optical path, of the data (or test) connector body are preserved to be similar to that of the alignment connector body, so as to eliminate or substantially reduce sources of discrepancies between the alignment optical connector and the data (test) optical connector. In other words, after using the alignment optical connector to precisely position the receptacle in optical alignment with the receptable in reference to the alignment optical ports in a first row (precisely offset to the second row of data optical ports on the device body), the data (or test) optical connector, being structured similarly to produce similar optical characteristics as the alignment optical connector, would likely be in optical alignment with the receptacle in reference to the data optical ports in the second row precisely offset from the first row of alignment ports.

In one embodiment, the data optical connector (or the optional test optical connector) comprises a connector body that is similarly configured as the alignment connector body, at least with respect to (a) the manner in which optical fibers are supported to input/output optical signals in accordance with similar defined optical path characteristics (including reflective surface geometry, beam divergence, mode field, structured reflective surfaces or microlens array, etc.), so as to replicate similar optical coupling between the alignment optical connector and the alignment ports at the device body and between the data optical connector (or test optical connector) and the data optical ports at the device body, and (b) the passive alignment features of the connector body similar to the passive alignment features of the alignment connector body, but with the passive alignment features referenced to the optical fibers in a manner wherein a first optical path of the alignment optical connector reaching the device body and a second optical path of the data optical connector (or test optical connector) reaching the device body are offset by a distance equivalent to the parallel spacing between the first row of data optical ports and second row of alignment ports at the device body.

In one embodiment, the data connector body supports, in a defined reference/relation (i.e., spatial relation) to the third set of passive alignment features, data optical fibers corresponding to the data optical ports of the optical data waveguides, wherein the first set of passive alignment features and the third set of passive alignment features provide passive alignment to define the demountable coupling between the receptacle and the data optical connector. Similar to the alignment optical connector, the data optical connector is removably attachable to the receptacle via the demountable coupling, with the first set of passive alignment features against the third set of passive alignment features, passively aligning the data optical connector relative to the receptacle attached to the device body in the aligned position in relation to the optoelectronic device, wherein the data optical fibers are optically aligned to the data optical ports of the optical data waveguides in the first row at the device body for transmission of data optical signals.

In one embodiment, a test optical connector is applied to test both the function of the optoelectronics device or PIC and the accuracy of positioning of the receptacle in relation to the optoelectronic device, by observing the optical coupling efficiency between the test optical connector and the optoelectronic device. The test optical connector may have similar configuration as the data optical connector (i.e., a test connector body similar to the data connector body). In other words, the test optical connector may be another data optical connector deployed for testing. While data optical signals are applied/received by the data optical connector during normal operations with the associated optoelectronic device, test optical signals relating to testing the integrity of the optoelectronic device or the optical alignment of the receptacle and/or of the optoelectronic device are applied by and received by the test optical connector when carrying out test procedures.

In another embodiment, the alignment connector body supports the alignment input and output optical fibers at an angle to the top surface of the device body, optically coupling the alignment input and output optical fibers to the alignment input and output ports on the device body, wherein the alignment connector body comprises a microlens array to expand the alignment optical signals from the alignment output optical fiber to the alignment input port. In this embodiment, the data connector body supports the data input and output optical fibers at an angle to the top surface of the device body, optically coupling the data optical fibers to the data optical ports on the device body, wherein the data connector body comprises a microlens array to expand the alignment optical signals from the data optical fibers to the data optical ports, whereby the optical path from the data optical fibers are offset with respect to the passive alignment features by a distance equivalent to the parallel spacing as compared to the alignment input and output fibers with respect to the passive alignment features.

In one embodiment, a master tool is provided as a reference datum to correlate related features of the alignment optical connector and the data/test optical connector during assembly of the alignment optical connector and the data/test optical connector, including aligning the second set of passive alignment features in relation to the alignment optical fibers, and aligning the third/fourth set of passive alignment features to the data/test optical fibers.

In one embodiment, passive alignment between the receptacle and the alignment optical connector and subsequent data optical connector (and optional test optical connector) may be achieved by passive, kinematic coupling, quasi-kinematic coupling, or elastic-averaging coupling. The passive alignment coupling allows a subsequent data optical connector to be detachably coupled to the device body associated with the optoelectronic device, via the receptacle that has been optically aligned to the device body. The data optical connector can be detached from the receptacle and reattached to the receptacle without compromising optical alignment. Accordingly, the optoelectronic device can be attached to a circuit board and after the circuit board is completely populated, a data optical connector with an optical fiber cable can be mechanically and functionally connected to the optoelectronic device on the circuit board. Consequently, the optical fiber cables are not in the way during the packaging processes and assembly of the circuit board.

The present invention enables optical alignment of a demountable coupling of an optical connector to an optoelectronic device which can be implemented with pick-and-place machinery with positioning accuracy on the order of about 1 micrometer or better. This is an adequate optical coupling accuracy for single-mode optical fiber connections.

In one embodiment, the grooves supporting the optical fibers and the structured reflective surfaces are integrally formed on the alignment connector body by stamping a malleable metal.

In one embodiment, the optoelectronic device is comprised in a wafer comprising an array of similar optoelectronic devices, wherein receptacles are attached to the device body of each optoelectronic device prior to or after dicing the wafer to separate the individual optoelectronic die for packaging. The optoelectronic device may comprise a photonic integrated circuit (PIC). After attaching the receptables to the device body of each optoelectronic device and prior to dicing the wafer or after dicing the wafer, active testing may be performed to assure functionality of the optoelectronic device and to verify the accuracy of the positioning of each receptacle by demountably coupling a test optical connector to the receptacle and energizing the optoelectronic device to determine optical signal coupling efficiency via the test optical connector (e.g., extent of insertion losses of optical signals).

The alignment, data, and/or test optical connectors may be a metallic PIC connector (MPC) developed by the assignee of the present invention. Furthermore, the optical connectors may be comprised in a multi-chip module (MCM) consisting of multiple PICs mounted onto a unifying common support (e.g., an organic PCB or glass interposer).

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIGS. 1A and 1B are schematics depicting wafer level processing of optoelectronic devices in electronic-photonic packaging industry, FIGS. 1C to 1E depict the alignment features of a receptacle attached to a die containing an optoelectronic device, and FIG. 1F is a schematic flow diagram depicting manufacturing from wafer level processing to electronic-photonic packaging, in accordance with one embodiment of the present invention.

FIGS. 2A to 2C are various views of a base of a connector body of an optical connector comprising an optical bench supporting an array of optical fibers, FIGS. 2D and 2E illustrate top and bottom surfaces of a cover plate of the optical connector body, in accordance with another embodiment of the present invention, and FIG. 2F illustrates an optical connector demountably attached to a device body of the optoelectronic device, in accordance with one embodiment of the present invention.

FIG. 3A and FIG. 3B are side views of a data/test optical connector and an alignment optical connector, respectively, in accordance with one embodiment of the present invention.

FIG. 4A and FIG. 4B are sectional views of a data/test optical connector and an alignment optical connector, respectively, in accordance with one embodiment of the present invention.

FIG. 5A schematically illustrates a first linear array of data optical ports on a PIC device body including grating couplers and waveguides for coupling active data optical signals of an active data optical connector to the optoelectronic device, and a second linear array of alignment optical ports including grating couplers and waveguides for loop-back active alignment of an alignment optical connector demountably coupled to a receptacle to the device body for precise positioning the receptacle to the device body, in accordance with one embodiment of the present invention; FIG. 5B schematically illustrates a second linear array of alignment optical ports for loop-back active alignment in accordance with another embodiment of the present invention.

FIGS. 6A to 6E schematically depict attachment of receptacles to PIC chips at a wafer level using an alignment optical connector, followed by wafer level testing using a testing optical connector, and subsequent dicing of the wafer into individual dies, in accordance with one embodiment of the present invention.

FIG. 7A illustrates enlarged views of a sequence of attaching a receptacle to a PIC chip at a wafer level, and FIG. 7B illustrates a flow diagram corresponding to the sequence in FIG. 7B, in accordance with one embodiment of the present invention.

FIG. 8A schematically depicts dicing a wafer of PIC chips into individual die prior to attaching a receptacle, and FIG. 8B is a schematic flow diagram depicting manufacturing from the wafer to testing individual die, in accordance with another embodiment of the present invention.

FIGS. 9A and 9B are schematics depicting wafer-on-wafer attachment of a wafer of receptacles to a wafer of PIC chips, in accordance with an alternate embodiment of the present invention.

FIG. 10 schematically depicts attachment of receptacles to PIC chips at a wafer level using a test/data optical connector, in accordance with another embodiment of the present invention.

FIG. 11A illustrates enlarged views of a sequence of attaching a receptacle to a PIC chip at a wafer level, and FIG. 11B illustrates a flow diagram corresponding to the sequence in FIG. 7B, in accordance with another embodiment of the present invention.

FIG. 12A and FIG. 12B are sectional views of a test/data optical connector in a first indexed location with respect to the receptacle for active alignment of the receptacle to the device body, and a second indexed location for testing and active use of the test/data optical connector, in accordance with one embodiment of the present invention.

FIGS. 13A to 13C schematically depict attachment of receptacles to PIC chips at a wafer level using an alignment optical connector, followed by wafer level testing using a testing optical connector, and subsequent dicing of the wafer into individual dies, in accordance with another embodiment of the present invention.

FIGS. 14A to 14D illustrate an alignment optical connector, in accordance with another embodiment of the present invention.

FIGS. 15A to 15D illustrate a test or data optical connector to correspond to the alignment optical connector in FIGS. 14A to 14D, in accordance with another embodiment of the present invention.

FIGS. 16A to 16C illustrate different embodiments of pre-alignment of a receptacle to a device body by passive alignment.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

The present invention provides an improved system and method of deployment of passively aligned demountable optical couplings for optoelectronic devices, which facilitates optical coupling efficiency testing for coupling to optical connectors, and/or functional testing of optoelectronic devices in the manufacturing process, to achieve improved tolerance, manufacturability, ease of use, functionality and reliability at reduced costs for optical connections to optoelectronic devices. In accordance with the present invention, optical alignment of a receptacle on a device body in reference to the optoelectronic device is achieved using an alignment optical connector demountably attached to the receptacle based on complementary/matching passive alignment features on the facing surfaces between the receptacle and the alignment optical connector, and an optical source and an optical receiver, external and functionally coupled to the alignment optical connector, providing to and receiving from the alignment optical connector an alignment optical signal transmitted in a passive loopback waveguide in the device body associated with the optoelectronic device. The inventive system and method implementing a passive alignment demountable coupling for an optical connector can achieve sub-micrometer optical alignment between the optical connector and the optoelectronic device, by using the optical receiver to measure the optical power of an optical alignment signal provided by the optical source via the loopback passive waveguide in the device body. The optimum, desired or targeted optically aligned position of alignment optical connector and the device body would represent the optically aligned position of the receptacle with respect to the device body. Once the receptacle is permanently attached to the device body at this aligned position, a data optical connector for regular/normal active operation with the optoelectronic device, which has similar passive alignment features facing the receptacle, can be demountably coupled to the receptacle by passive alignment of the optical connectors and the receptacle.

The alignment of demountable coupling concept of the present invention is discussed hereinbelow by reference to the example of a photonic integrated circuit (PIC) chip as an optoelectronic device and an optical connector comprising an optical bench, and optically coupling an input/output end of an optical component (e.g., an optical fiber) supported in the optical bench with the optoelectronic device. Further, the present invention is discussed hereinbelow by reference to elastic averaging alignment coupling as an example of passive alignment demountable coupling of, e.g., an optical connector to a receptacle on a device body associated with an optoelectronic device. The present inventive concepts may be applied to other types demountable, removable and reconnectable couplings (e.g., kinematic coupling, quasi kinematic coupling, etc.) for other components that require maintaining precise alignment for each connect and disconnect and reconnect.

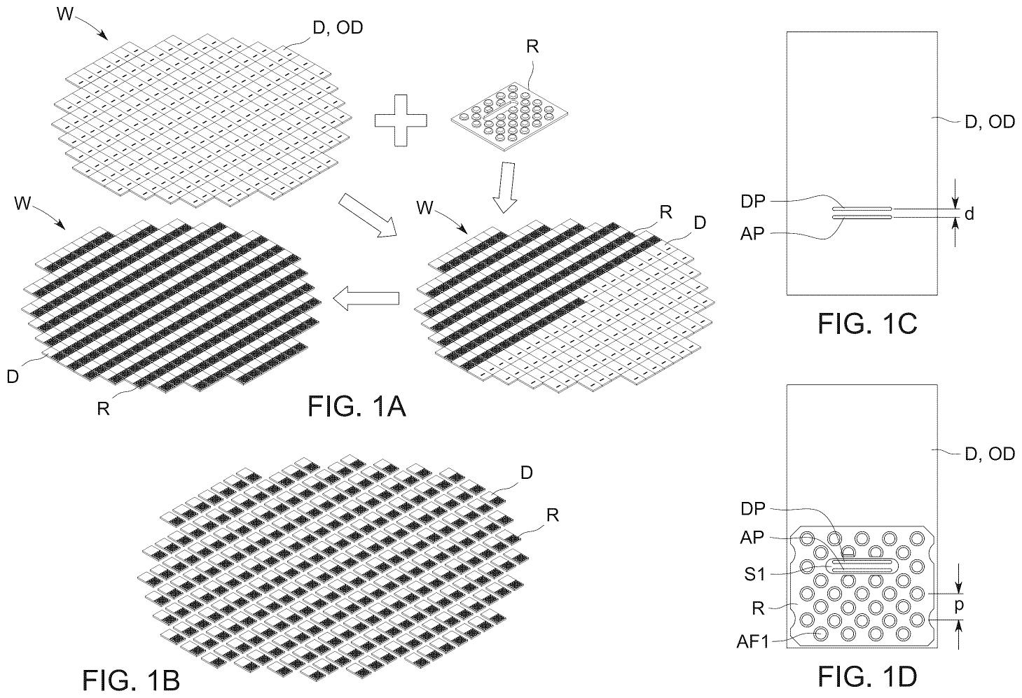

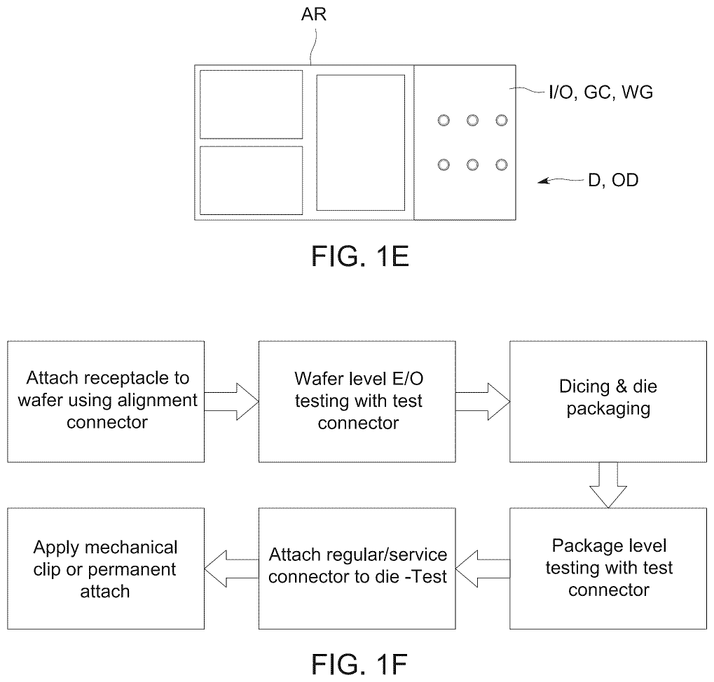

In one embodiment, the optoelectronic device OD is comprised in a wafer W comprising an array of similar optoelectronic devices and device bodies thereof, wherein the receptacles R are attached to individual device body D of individual optoelectronic device prior to dicing the wafer to separate the individual optoelectronic devices. FIG. 1A schematically depicts an embodiment of a wafer W comprising a plurality of similar optoelectronic devices OD, e.g., PIC dies, each to be attached with a receptacle R across the entire wafer by active alignment in accordance with the present invention, followed by dicing into individual dies in FIG. 1B. FIG. 1C depicts a plan view of a device body D of the optoelectronic device comprising a first and second linear arrays of input/output (I/O) optical ports, including a first row of data optical ports DP for normal operation I/O via optical data waveguides with the optoelectronic device OD, and a second row of alignment optical ports AP for positioning the receptacle R in optical alignment with the device body D and hence the optoelectronic device OD, via one or more loopback optical alignment waveguide. Each I/O optical port may include a grating coupler with or without a microlens associated with a waveguide provided in the device body, for input/output of optical signals from an optical connector. The first row of data optical ports DP is parallel to and spaced apart from the second row of alignment optical ports AP by a parallel spacing d. The relationship and functions of the first and second linear arrays of optical ports will be further discussed in detail below.

FIG. 1D depicts a 2-dimensional array of passive alignment features AF1 of the receptacle R for demountable coupling, as attached to a die of the device body D containing an optoelectronic device OD. As will be further explained below, the passive alignment features AF1 correspond to elastic averaging features for demountable coupling to matching/complementary elastic averaging features on a designated device (e.g., passive alignment features AF2 corresponding to elastic averaging features at the bottom of the optical connector described herein).

FIG. 1E schematically depicts the device body D comprising the active region AR of the functional integrated optoelectronic components of a PIC chip on a substrate (diced from the wafer) and the I/O ports, grating couplers GC and waveguides WG corresponding to the receptacle R, in accordance with one embodiment of the present invention. In the context of the present invention, the active region of the optoelectronic device is the region where optical paths are defined for transmissions of optical data signals between the optical connector and the optoelectronic device during normal active operations of the optoelectronic device. In this embodiment, the passive optical alignment waveguide AWG (to be discussed below) is disposed outside the active region AR of the optoelectronic device OD.

In reference to FIGS. 1A and 1B, FIG. 1F schematically summarizes manufacturing from wafer level processing of a wafer comprising optoelectronic devices OD/device bodies D through testing and packaging processes, in accordance with one embodiment of the present invention. Starting with the wafer processed with optoelectronic devices OD/device bodies D, a receptacle R is positioned with respect to and attached to a device body D in accordance with the present invention to be further explained below. Using a test optical connector TC, the optoelectronic device OD may be electro-optical (E/O) function tested at the wafer level via the active I/O data optical ports DP, prior to dicing the wafer into individual dies in FIG. 1B. This allows for grading and sorting of dies according to the degree to which the dies satisfy performance specifications. After dicing, the dies may be packaged into a packaged device or multichip module, followed by package level functional testing with the test optical connector TC. The packaged device may be further tested with a regular/service data optical connector. The packaged device with the receptacle may be permanently attached to a supporting circuit board, e.g., a printed circuit board (PCB), or demountably attached thereto using, e.g., a mechanical clip. It is understood that the testing procedures are available but optional and depending on the level of quality assurance for manufacturing process to be achieved, one or more of the testing procedures may be omitted.

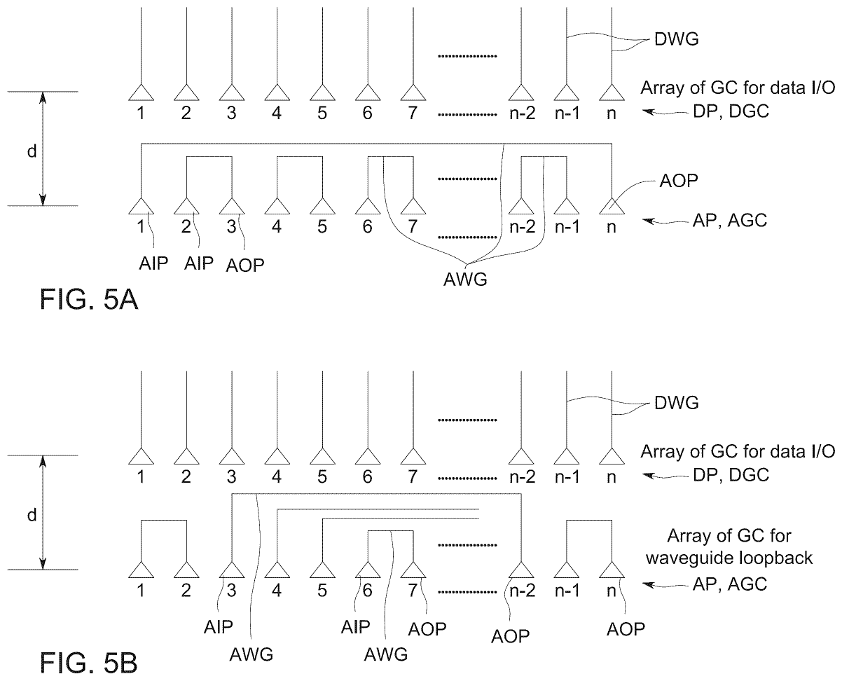

Referring back to FIG. 1C, FIG. 5A schematically illustrates an embodiment of a first linear array (1×n) of data optical ports DP on a PIC device body D including data grating couplers DGC and data waveguides DWG, and a second linear array (1×n) of alignment optical ports AP including alignment grating couplers AGC and alignment waveguides AWG. The data optical ports DP are each defined by a data grating coupler DGC associated with an optical data waveguide DWG. The data grating couplers DGC couple active data optical signals of an active data optical connector to the optoelectronic device via the data waveguides DWG. The alignment optical ports AP of the alignment waveguides AWG are each defined by an alignment grating coupler AGC. As illustrated, each pair of alignment grating couplers AGC and associated alignment waveguide AWG provide for loop-back active alignment of an alignment optical connector demountably coupled to a receptacle R in reference to the device body D for precise positioning the receptacle R on the device body D. FIG. 5B schematically illustrates an alternate embodiment of a second linear array of alignment optical ports AP for loop-back active alignment having different pairing of an alignment input port AIP to an alignment output port AOP. There should be at least one pair of alignment grating couplers AGC defining one pair of alignment optical ports AP, including an alignment input port AIP at one end and an alignment output port AOP at another end of an alignment waveguide AWG.

Accordingly, the optoelectronic device OD comprises a device body D (e.g., a housing of the optoelectronic device, an interposer, etc.) associated with the optoelectronic device OD. The device body D comprises a first linear array of at least two active data optical ports DP (i.e., active input/output (I/O) ports for grating couplers arranged in a first row, corresponding to optical data waveguides DWG communicating active data optical signals with the optoelectronic device, and a second linear array of at least a pair of alignment optical ports AP (e.g., grating couplers) including an alignment input port AIP and an alignment output port AOP arranged in a second row parallel to and spaced from the first row of data optical ports by a parallel spacing d, wherein each pair of alignment optical ports AP correspond to a loopback optical alignment waveguide AWG at a defined location in relation to data optical ports DP. The receptacle R comprises a bottom surface attached to a top surface of the device body D. A first set of passive alignment features AF1 is defined on a planar top surface of the receptacle R in a defined reference/relation to the data optical ports DP and the alignment optical ports AP (comprising at least one pair of alignment input ports AIP and alignment output ports AOP).

In these embodiments, the locations of the second linear array/the second row of alignment optical ports AP do not extend beyond the first linear array/the first row of data optical ports DP in a parallel direction. The second row of alignment optical ports AP is same length with same number of ports as the first row of data optical ports. Alternatively, not shown, the second row of alignment data ports AP may be shorter and/or with lesser number of ports than the first row of data optical ports DP. The number of data optical ports DP may be greater than or equal to the number of alignment optical ports AP (i.e., at most as many alignment optical ports AP as the data optical ports DP). In the illustrated embodiments, each alignment optical port AP is adjacent to a data optical port DP in a direction perpendicular to the parallel direction of the first and second rows. Specifically, the data optical ports DP and the alignment optical ports AP are arranged in a 2×n matrix, where n=number of ports in a row, with the two rows separated by a parallel distance d.

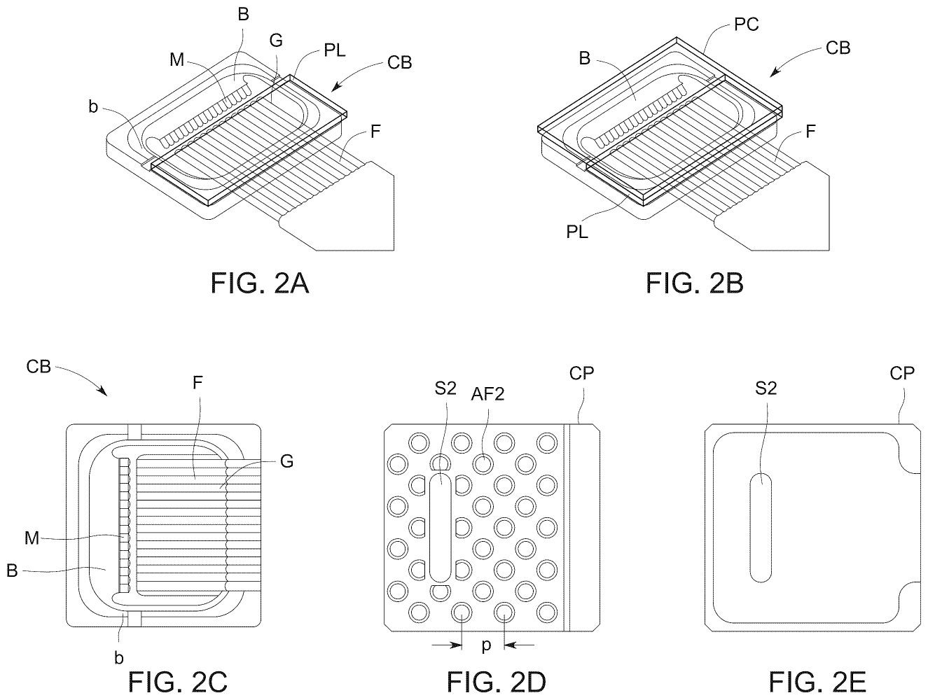

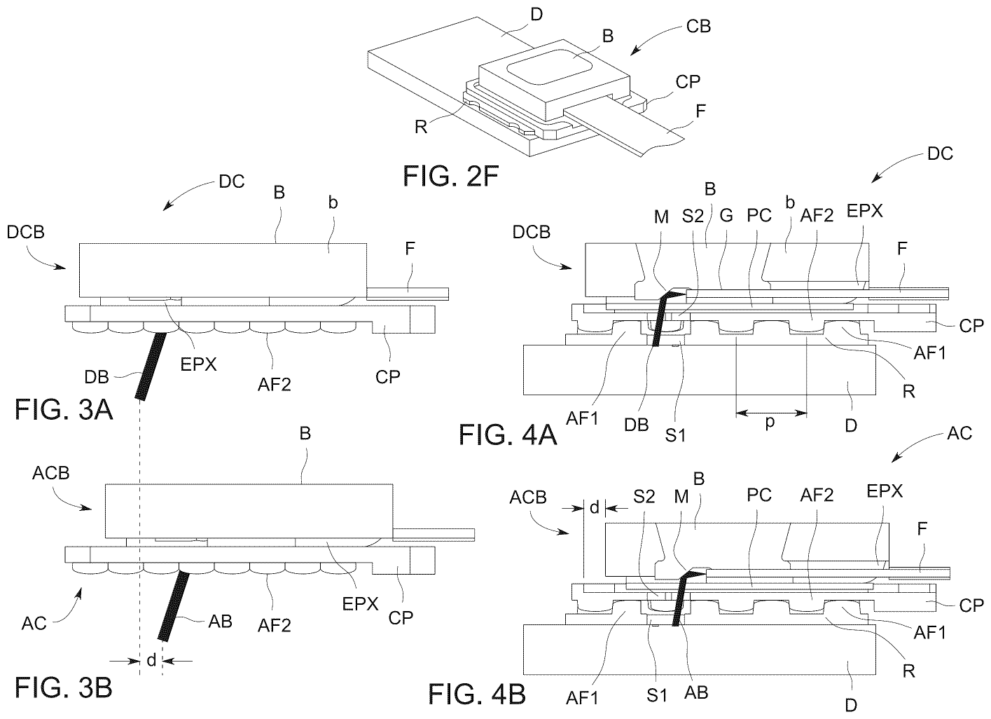

The general configuration and structure of an optical connector C will be described in reference to FIGS. 2A to 2F. Similar configuration and structure of the optical connector C may be implemented for the alignment optical connector AC, the test optical connector TC and/or the data optical connector DC.

FIGS. 2A to 2C are various views of a connector body CB of an optical connector C comprising an optical bench B supporting an array of optical fibers F (e.g., in the form of a fiber array cable). As shown in FIGS. 2A and 2C, the optical bench B includes an array of structured reflective surfaces in the form of micromirrors M defined thereon, which correspond to an array of waveguides in the form of optical fibers F. In the illustrated embodiment, optical bench B comprises a body or base b supporting the array of optical fiber F transmitting an optical signal. The optical bench accurately supports the exit ends of the optical fibers F with respect to the micromirror array M, and further in reference to the exterior (e.g., the top side in FIG. 1B) of the base b. The base b thus provides an alignment reference to the mirrors M and the optical fibers F. As will be further explained below, the optical bench B aligns the optical fiber F to communicate optical signals with the device body D of an external optoelectronic device (e.g., a PIC chip).

More specifically, referring also to FIG. 4A (which illustrates the configuration of an optical connector specifically for a data optical connector DC further discussed below), base b of the optical bench B defines structured features including an alignment structure comprising open grooves G for retaining bare sections of optical fibers F (having their cladding exposed, without protective buffer and matrix/jacket layers), and structured reflective surfaces (e.g., eight, twelve, sixteen, eighteen, or twenty mirrors M). The open grooves G are sized to receive and located to precisely position the end section of the optical fibers F in alignment with respect to the array of mirrors M along an optical path. The end face (input/output end) of each of the optical fibers F is maintained at a pre-defined distance with respect to a corresponding mirror M. A clamping plate PL is provided to retain optical fibers F in the respective grooves G, e.g., by clamping the optical fibers F against the grooves G, with the optical fibers F in direct contact with the clamping plate PL and the grooves G to secure and maintain alignment of the optical fibers F in the grooves G. In the illustrated embodiment of FIG. 2B, a transparent glass, quartz, sapphire, or silicon plate cover PC is further provided to cover the exposed surfaces on the optical bench B to protect the mirrors M. In one embodiment, the optical bench B may be filled with index-matching epoxy EPX between the mirror surfaces M and the plate cover PC.

In one embodiment, each mirror M is an exposed free surface of the base b of the optical bench B having an exposed reflective free side facing away from the base b (i.e., a surface exposed to air or not internal within the body of the base of the optical bench). The exposed reflective free side comprises a structured reflective surface profile at which light is directed to and from the optical fiber F and to and from the device body to which the optical connector C optically coupled. Each mirror M bends, reflects (e.g., by a non-zero angle such as 90 degrees) and/or reshapes an incident light. Depending on the geometry and shape (e.g., curvature) of the structured reflective surface profile, the mirrors M may collimate, expand, converge, or focus an incident light beam. For example, the structured reflective surface profile may comprise one of the following geometrical shape/profiles: (a) ellipsoidal, (b) off-axis parabolic, or (c) other free-form optical surfaces. For example, the mirror surface, to provide optical power, may have a surface geometrical curvature function of any of the following, individually, or in superposition: ellipsoidal or hyperbolic conic foci, toroidal aspheric surfaces with various number of even or odd aspheric terms, X-Y aspheric curves with various number of even or off terms, Zernike polynomials to various order, and various families of simpler surfaces encompassed by these functions. The surfaces may also be free-form surfaces with no symmetry along any plane or vector. The mirrors M may be defined on the base b by stamping a malleable metal material. Various malleable metals, stampable with tool steels or tungsten carbide tools, may compose the body of the mirrors, including any 300 or 400 series stainless steel, any composition of Kovar, any precipitation or solution hardened metal, and any alloy of Ag, Al, Au, Cu. At the long wavelengths above 1310 nm, aluminum is highly reflective (>98%) and economically shaped by stamping. The reflective surface of the portion of the metal comprising the optical bench B may be any of the metals mentioned above, or any coating of highly reflective metal, applied by sputtering, evaporation, or plating process.

FIGS. 2D and 2E illustrate a cover plate CP of the optical connector body CB, which is provided with two-dimensional planar array of a second set of passive alignment features AF2 on the connector body CB which matches/complements the first set of passive alignment features AF1 on the top of the receptacle R. The connector body CB includes a separate cover plate CP attached to the bottom of the base, wherein an exposed surface of the cover plate CP (i.e., the bottom surface of the connector body CB) is defined with the second set of passive alignment features AF2.

The cover plate CP in this embodiment and other embodiments described below can be made of transparent materials (e.g. glass, silicon, or a thermosetting polymer) or opaque materials (e.g. metals like invar, kovar). Preferably the materials should have a coefficient of thermal expansion that is nearly identical to or matches the coefficient of thermal expansion of the receptacle, device body, and/or PIC. In the embodiment illustrated in FIGS. 2D and 2E, the cover plate CP and alignment features AF are made of invar (FeNi36) to match the CTE of the receptacle and nearly match the CTE of a silicon PIC. Since invar is opaque to near infrared light, the cover plate CP has an aperture window S2 allowing light to pass between the connector and I/O ports in the optoelectronic device.

Passive alignment features applicable for the demountable passive alignment coupling may be at least one of kinematic coupling, quasi-kinematic coupling, and elastic averaging coupling. The illustrated embodiments hereinabove, and hereinbelow, adopted passive alignment features directed to elastic averaging alignment features disclosed in US Patent Publication No. 2024/0085633A1 and US Patent Publication No. 2024/0142722A1 (both commonly assigned to the assignee of the present application and fully incorporated by reference herein), which are well applied for demountable passive alignment couplings between optical connectors and optoelectronic devices. As described and illustrated, the first passive alignment features AF1 is a first two-dimensional array of alignment features on top surface of the receptacle, and the matching passive alignment features AF2 is a second two-dimensional array of alignment features on bottom surface of connector. Details of the passive alignment feature AF1 and AF2 disclosed herein may be referenced from these patent publications.

FIG. 2F illustrates an optical connector C demountably attached to a device body D of the optoelectronic device, in accordance with one embodiment of the present invention. The deployment of the optical connector body CB for the alignment optical connector AC and the data/test optical connector DC/TC would require a different relative positioning with respect the cover plate CP, as will be explained in greater detail below.

FIG. 3A and FIG. 3B are side views of a data optical connector DC (or test optical connector TC) and an alignment optical connector AC. FIG. 4A and FIG. 4B are sectional views of a data optical connector DC (or test optical connector TC) and an alignment optical connector AC, respectively. In the illustrated embodiment, the configuration and structure of the connector body CB for the alignment optical connector AC, data optical connector DC and test optical connector TC may be substantially similar, at least with respect to: (a) manner in which optical fibers F are supported to input/output optical signals in accordance with similar defined optical path characteristics (including beam shape and angle, reflective surface geometry, beam convergence/divergence, mode field, structured reflective surfaces or microlens array, etc.), so as to replicate similar optical coupling between the alignment optical connector AC and the alignment ports AP at the device body D and between the data optical connector DC (or test optical connector TC) and the data optical ports DP at the device body D, and (b) passive alignment features AF2 (i.e., the set of passive alignment features AF2 of the data connector body DCB, the alignment connector body ACB and the test connector body TCB), but with the cover plate CP having the passive alignment features AF2 referenced to the optical fibers F in a manner wherein a first optical path AB of the alignment optical connector AC directed to and from the device body D and a second optical path DB of the data optical connector DC (or test optical connector TC) directed to and from the device body are offset by a distance equivalent to the parallel spacing d between the first row of data optical ports DP and second row of alignment ports AP at the device body D, as more clearly illustrated by FIGS. 3A and 3B.

In one embodiment, this offset is accomplished without requiring any change of the optical bench B as between the alignment connector body ACB and the data connector body DCB (or test connector body TCB), and the cover plate CP of the alignment connector body ACB or the data connector body DCB (or the test connector body TCB). The same optical bench B is adopted in the data (or test) connector body and the alignment connector body. As more clearly illustrated in FIGS. 4A and 4B, the light beam along optical path DB and optical path AB are similarly collimated on one side of each corresponding mirror M, and similarly converging/diverging at the other side of each corresponding mirror M, with an offset of parallel spacing d. The offset is accomplished by shifting the optical bench B of the alignment connector body ACB relative to its cover plate CP by the parallel spacing d, as compared to the relative position of the optical bench B and the cover plate CP of the data (or test) connector body DCB (or TCB). Comparing the attachment of the cover plate CP to the base of the data connector body DCB with the attachment of the cover plate CP to the base of the alignment connector body ACB, the location of the base of the data connector body DCB with respect to the cover plate CP and the location of the base of the alignment connector body ACB with respect to the cover plate CP are displaced by an offset equivalent to the parallel spacing b.

In accordance with the present invention, the alignment optical connector AC comprises an alignment connector body ACB that comprises a second set of passive alignment features AF2 defined on a planar bottom surface of cover plate CP, matching/complementary to the first set of passive alignment features AF1 defined on the top surface of the receptacle R. The first set of passive alignment features AF1 and the second set of passive alignment features AF2 provide passive alignment to define a demountable coupling between the receptacle R and the alignment optical connector AC. The alignment optical connector AC is removably attachable to the receptacle R via the demountable coupling, with the first set of passive alignment features AF1 against the second set of passive alignment features AF2, thereby passively aligning the alignment optical connector AC relative to the receptacle R. The alignment connector body AC supports, in a defined spatial reference/relation to the second set of passive alignment features AF2, at least an alignment output optical fiber F corresponding to the alignment input port AIP of the optical alignment waveguide AWG in the second row at the device body D and an alignment input optical fiber corresponding to the alignment output port AOP of the optical alignment waveguide AWG in the second row at the device body D.

In the illustrated embodiment of FIGS. 2 to 4, the alignment connector body AC supports the alignment input and output optical fibers substantially parallel to the top surface of the device body D, wherein the alignment connector body AC comprises an optical bench B supporting the alignment input and output optical fibers. The optical bench comprises a first linear array of structured reflective surfaces/mirrors M (free form reflective surfaces, e.g., concave reflective) defined in reference/relation to the second set of passive alignment features AF2, each optically aligned with the respective alignment input and output optical fibers. The alignment output and input optical fibers are optically coupled to the alignment input port AIP and alignment output, respectively, on the device body D via the first array structured reflective surfaces M. The first array of structured reflective surfaces/mirrors M comprises a first reflective surface/mirror M redirects and expands (e.g., collimates) the alignment optical signal from the alignment output optical fiber to the alignment input port AIP, and a second reflective surface/mirror M redirects and converges (e.g., focuses) the alignment optical signal from the alignment output port AOP to the alignment input optical fiber.

In the embodiments illustrated in FIGS. 5A and 5B, the number of alignment optical ports AP in the second row is the same as the number of data optical ports DP in the first row. Alternatively, the number of alignment optical ports AP may be less than the number of data optical ports DP in the first row (not shown). In which case, the optical bench B in the alignment optical connector AC can be maintained the same as before, and the number of mirrors M in the optical bench B can remain the same as in the previous embodiment, but the number of “active” mirrors and “active” optical fiber F would be less, conforming to the lesser number of alignment optical ports AP. This is consistent with the advantage of maintaining similar physical structure and configuration between the alignment optical connector AC and the data optical connector DC (or test optical connector TC) to reduce potential alignment errors resulting from different physical structure and configuration between the alignment optical connector AC and the data optical connector DC.

Referring back to FIG. 1D, the receptacle R may be optically transparent (e.g., a transparent semiconductor) (not shown). In the illustrated embodiment, the receptacle R is provided with an opening in the form of a slot S1 located within the first set of passive alignment features AF1, corresponding to the data optical ports DP and the alignment optical ports AP, thereby providing a clearance for the optical paths DB and AB for the data optical ports DP and the alignment ports AP. Alternately, not shown, a cutout may be provided at one edge of the first set of passive alignment features, providing clearance for the optical paths DB and AB for the data optical ports DP and the alignment optical ports AP. The openings, or cutout, allows data optical signals to transmit between the data optical ports DP and the data optical fibers, and alignment optical signals to transmit between the alignment optical ports AP and the alignment input and output optical fibers.

Referring to FIG. 2D, the cover plate CP may be optically transparent (e.g., a transparent semiconductor) (not shown). In the illustrated embodiment, the cover plate CP is provided with a window or opening in the form of a slot S2 located within the second set of passive alignment features AF2, corresponding to the data optical ports DP and optical alignment optical ports AP, thereby providing a clearance for the optical paths DB and AB for the data optical ports DP and the alignment ports AP. Alternately, not shown, a cutout may be provided at one edge of the second set of passive alignment features, providing clearance for the optical paths DB and AB for the data optical ports DP and the alignment optical ports AP. The openings, or cutout, allows data optical signals to transmit between the data optical ports DP and the data optical fibers, and alignment optical signals to transmit between the alignment optical ports AP and the alignment input and output optical fibers.

Referring back to FIG. 4A, as mentioned above, the data optical connector DC may have the same optical bench B as in the alignment optical connector AC, and with the same cover plate CP that is attached to the optical bench B with an offset with respect to the optical bench B by a parallel spacing d. Hence, the data optical connector DC likewise comprises the data connector body DCB having a third set of passive alignment features AF3 (that is similar to the second set of alignment features AF2 on a planar bottom surface of cover plate CP), matching/complementary to the first set of passive alignment features AF1 on the top surface of the receptacle R. The data connector body DCB supports, in a defined spatial reference/relation to the third set of passive alignment features AF3, data optical fibers corresponding to the data optical ports DP of the optical data waveguides DWG, wherein the first set of passive alignment features AF1 and the third set of passive alignment features AF3 provide passive alignment to accomplish the demountable coupling between the receptacle R and the data optical connector DC. The data optical connector DC is removably attachable to the receptacle R via the demountable coupling with the first set of passive alignment features AF1 against the third set of passive alignment features AF3, passively aligning the data optical connector DC relative to the receptacle R attached to the device body D in the aligned position in relation to the optoelectronic device. The data optical fibers are optically aligned to the first row of data optical ports DP of the optical data waveguides DWG at the device body D for transmission of operational data optical signals.

The test optical connector is applied to actively test accuracy of positioning of the receptacle R in relation to the device body D/optoelectronic device OD, by observing the optical coupling efficiency between the test optical connector TC and the optoelectronic device OD. Referring to FIG. 4A, as mentioned above, the test optical connector TC may also have the same optical bench B as in the alignment optical connector AC, and with the same cover plate CP that is attached to the optical bench B with an offset with respect to the optical bench B by a parallel spacing d. Accordingly, the test optical connector TC may be similar in physical structure and configuration as the alignment optical connector AC, as well as the data optical connector DC. In other words, the test connector TC may be simply another data optical connector DC deployed specifically for testing accuracy of positioning of the receptacle R in relation to the device body D. Optical signals conforming to specific test protocols are supplied through selected optical fibers F supported in the test optical connector TC, and the optical coupling efficiency between the test optical connector TC and the optoelectronic device OD is determined by observing optical power received by selected optical fibers F supported in the test optical connector TC.

In accordance with one aspect of the present invention, the configuration and structure of the receptacle R and the matching/complementary cover plate CP are unique in that they each include an aperture window or opening S1/S2 located within a corresponding surrounding set of matching passive alignment features AF1/AF2 for transmission of alignment and data optical paths. This places the optical paths closer to the center (or centroid) of the passive alignment features, which would result in more precise passive alignment from the matching passive alignment features, especially for elastic averaging alignment. The receptacle R and the matching cover plate CP are relatively thin pieces that can be easily attached/bonded to a surface, e.g., device body D and optical bench B of a connector body CB, for demountable coupling based on passive alignment.

As explained above, the receptacle R as well as the cover plate CP are both compatible with the various optical connectors AC, DC and TC. The different connector bodies ACB, DCB and TCB of the optical connectors AC, DC and TC could adopt the same optical bench B and cover plate CP, with appropriate shifting of the position of the optical bench B relative to cover plate CP by an offset equivalent to the parallel spacing d between the row of alignment ports AP and the row of data optical ports DP of the device body D. Referring to FIGS. 4A and 4B, the aperture window S1/S2 are shaped and sized to allow alignment optical beam path AB and data optical beam path DB to transmit therethrough between the device body D and respective alignment optical connector AC, data optical connector DC and test optical connector TC. As shown in FIGS. 1D and 2D, the windows S1 and S2 do not obstruct the parallel rows of ports AP and DP. Each window S1/S2 is shaped in an elongated slot, with a length (as measured in the parallel direction of ports AP and DP) longer than the parallel rows of ports AP and DP, and a width (as measured in the direction perpendicular to the parallel rows of ports AP and DP) wider than parallel spacing d, with sufficient clearance to accommodate the beam paths AB and DB unobstructed.

To accommodate receptacles R at wafer level, the receptacle R should fit within the perimeter of the opposing top surface of the device body D, hence the overall dimensions (i.e., length and width) of a receptacle R should be smaller than the dimension of the opposing top surface of the device body D, as shown in FIG. 1D. For the cover plate CP, as shown in FIGS. 2D and 2F, while it is generally desirable to keep the overall size of an optical connector to be as small as possible for practical applications with limited space for accommodating optical connectors, the cover plate CP does not need to fit within the perimeter of the opposing top surface of the device body D, or be sized to be the same as receptacle R. As shown in FIGS. 2F, 4A and 4B, the cover plate CP extends beyond an edge of the receptacle R as well as an edge of the device body D. The area of the array of passive alignment features AF2 distributed on the underside of the cover plate CP is similar to the area of the array of passive alignment feature AF1 distributed on the opposing top side of the receptacle R.

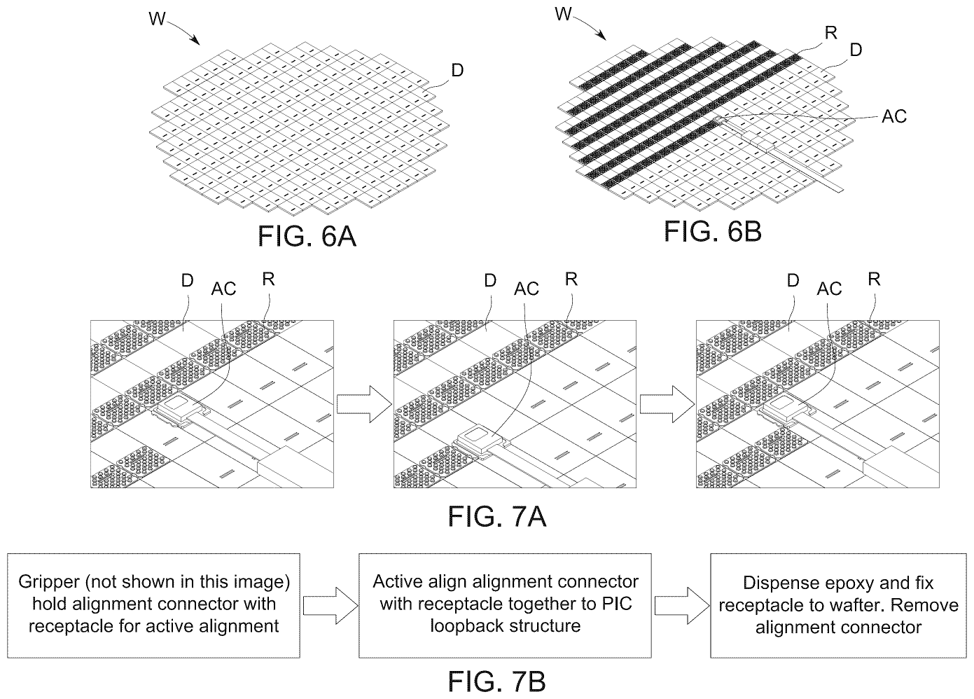

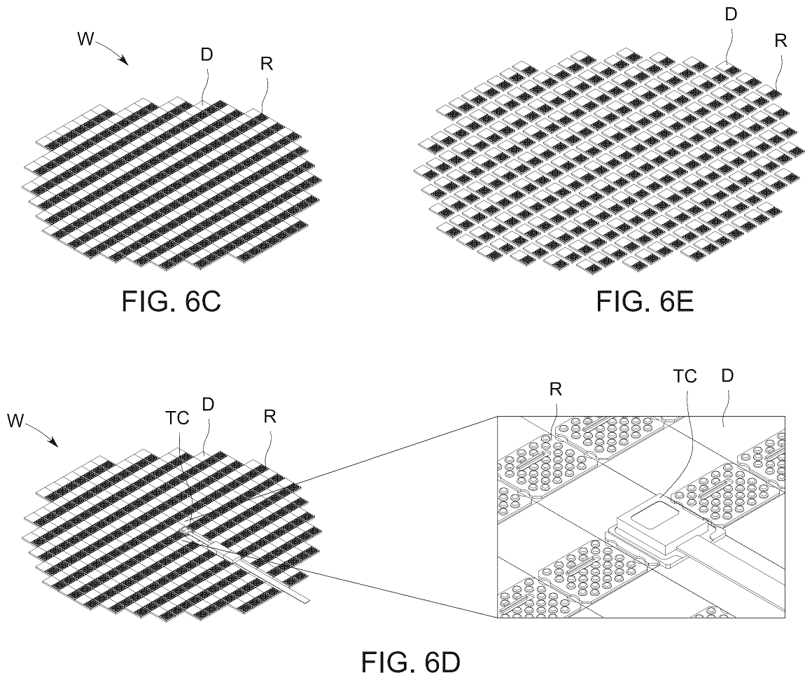

FIGS. 6A to 6E further illustrate an embodiment of a process for attachment of receptacles R to device bodies D of PIC chips at a wafer level using an alignment optical connector, followed by wafer level testing using a testing optical connector (to be discussed below), and subsequent testing and dicing of the wafer into individual dies (some of the steps are also depicted in FIG. 1F), in accordance with one embodiment of the present invention. FIG. 7A illustrates enlarged views of a sequence of attaching a receptacle to a PIC chip at a wafer level, and FIG. 7B illustrates a flow diagram corresponding to the sequence in FIG. 7B, in accordance with one embodiment of the present invention.

FIG. 6A shows a wafer W comprising a plurality of the same device bodies D. FIG. 6B depicts placement and attachment of receptacles R on the device bodies D on the wafer W by active alignment using an alignment optical connector AC. Referring also to FIG. 7A, with the alignment optical connector AC demountably/removably attached to the receptacle, a precision mechanical gripper (not shown) holds and manipulates the alignment optical connector AC with the receptacle for active alignment. Active alignment of the alignment optical connector AC with the receptacle R demountably attached thereto is via an alignment signal through the loopback waveguide AWG. Specifically, the alignment output optical fiber outputs an alignment optical signal from an external optical source to the alignment input port AIP. The alignment optical signal is transmitted via the optical alignment waveguide AWG to the alignment output port AOP. The alignment input optical fiber receives and forwards the alignment optical signal to an external optical receiver. By adjusting the relative position between the alignment connector body ACB and hence the receptacle attached thereto with respect to the device body D, the aligned position (i.e., the position of optimum optical alignment) can therefore be determined by the active alignment between the receptacle and the device body D, based on observing the active alignment optical signal received in relation to the position of the receptacle R relative to the device body D (e.g., at a detected maximum optical power with the least insertion loss or optical signal attenuation). The external optical source and external optical receiver are operatively controlled by an external controller operating in accordance with protocols consistent with optical alignment via loopback waveguide described herein. Further references may be made to the loopback methodologies disclosed in US Patent Publication No. 2024/0085633A1 and US Patent Publication No. 2024/0142722A1 (both commonly assigned to the assignee of the present application and fully incorporated by reference herein),

After the receptacle has been precisely positioned by active alignment on the device body D, it can be permanently attached (e.g., by welding, soldering, epoxy, etc.) to the device body D at the aligned position. The alignment optical connector AC is then removed, e.g., by the gripper. The receptacle R thereby provides a demountable coupling for data optical connectors DC after the alignment optical connector AC has been removed post aligning the receptacle R to the device body D.

In FIG. 6C, the entire wafer W was populated with receptacles R. In FIG. 6D, at the wafer level (i.e., prior to dicing the wafer W), a test optical connector TC is used to actively test the electro-optical functions of the optoelectronic device OD associated with each device body D. A test optical connector TC is demountably coupled to each receptacle R and the optoelectronic device is energized to evaluate the optical signal coupling efficiency via the test optical connector TC (e.g., extent of insertion losses of optical signals). This functional testing procedure can identify devices that do not meet tolerance and/or performance standards, possibly due to issues with inaccuracy in positioning and alignment of the receptacle onto device body D, defects in the optoelectronic device OD, and/or other defects. In FIG. 6E, the wafer F is diced and individual devices D are produced each with a receptacle attached thereon. The devices that do not meet standards are rejected upon dicing.

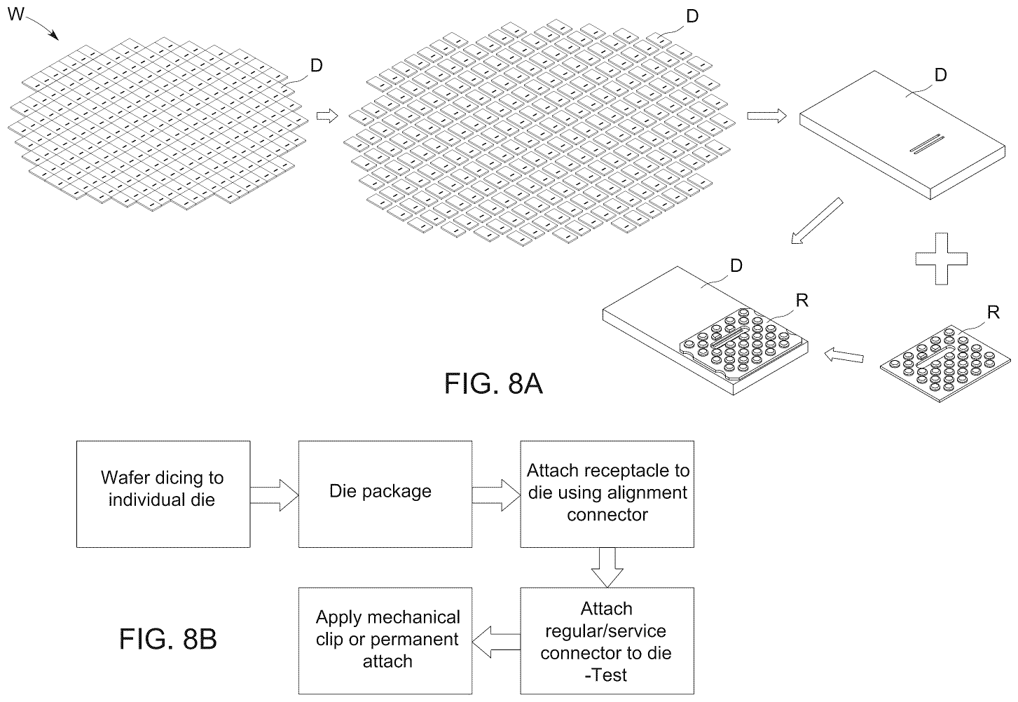

Alternatively, alignment and attachment of the receptacle R onto a device body D, as well as functional testing of individual devices can be performed after dicing. FIG. 8A schematically depicts dicing a wafer of PIC chips into individual die packages prior to attaching a receptacle R to the device body D. FIG. 8B is a schematic flow diagram depicting wafer dicing to individual die package of device body D, attaching the receptacle R to each device body D, to testing individual die package, in accordance with another embodiment of the present invention. In this embodiment, a data optical connector DC may be used instead of a test optical connector TC for testing, since the former is similar to the latter, to conduct active functional testing of the die package based on testing protocols. The tested and accepted die package can then be permanently attached to a circuit board or substrate.

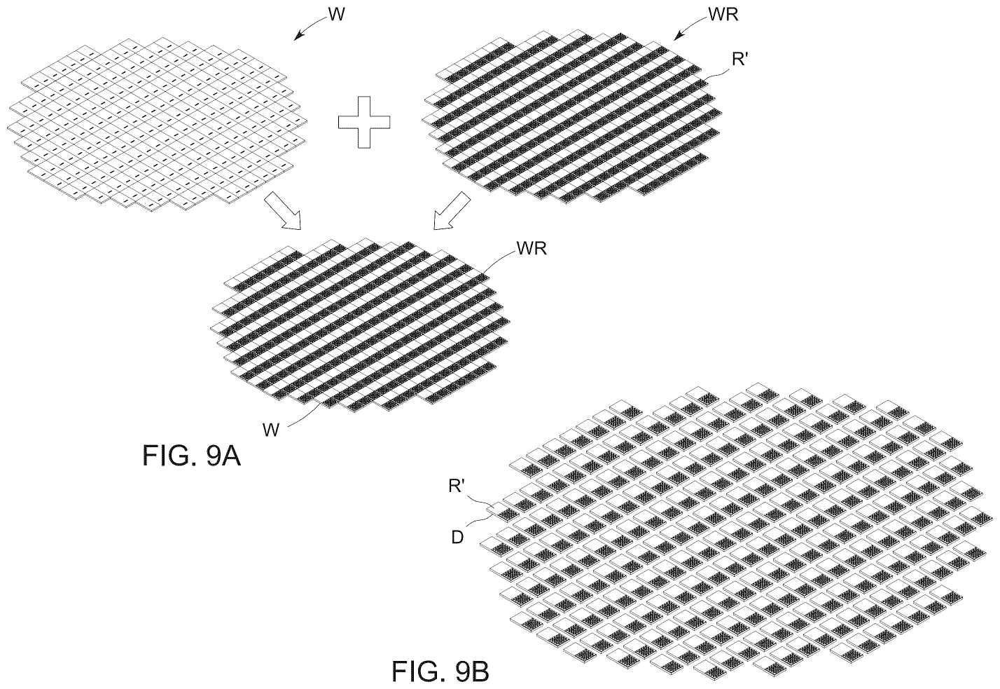

FIGS. 9A and 9B schematically depict wafer-to-wafer alignment and attachment of a receptacle wafer WR (of receptacles R′) to a device wafer W (of PIC chips), instead of placement and attachment of individual receptacles R onto a wafer populated with devices, in accordance with an alternate embodiment of the present invention. In this embodiment, the receptacle R′ is part of a receptacle wafer WR comprising an array of similar receptacles R′, wherein the receptacles R′ of wafer WR are positioned and attached to the wafer W of optoelectronic devices or device bodies D by active alignment using a number of alignment optical connectors AC.

In this embodiment, the receptacle R′ extends to cover the device body D given the receptacles R′ are diced from a wafer, with a region of passive alignment features AF2 and slot S2 resembling the area of alignment features AF2 and slot S2 on the cover plate CP in FIG. 2D. The receptacle wafer WR may be a semi-conductor material (e.g., silicon), glass, or metal (e.g., aluminum, Kovar, tungsten carbide, etc.). In this embodiment, the receptacle wafer WR can be aligned to devices D on the wafer W using concurrently a plurality of alignment optical connectors AC as described above to concurrently align with a plurality of device D in the manner described earlier. The number of alignment optical connectors R′ used would depend on the tolerance level achievable. For example, a collection of alignment optical connectors AC can be used to position the entire wafer of receptacles R′ by aligning in parallel or concurrently the receptacles R′. The collection of alignment optical connectors AC can be arranged about the surface of the wafer of receptacles WR. At a minimum, two active alignment optical connectors on opposite edges of the wafer WR are used to set the position and orientation of wafer WR with respect to the wafer W. However, more than two active alignment connectors AC assist in alignment since manufacturing errors within the wafers W and WR cause individual receptacles R to be slightly offset with respect to the device body or opto-electronic device in the wafer W. It is reasonable to use five alignment optical connectors arranged with one connector at the center of the wafer and four connectors located at the perimeter of the wafer at 90 degree increments. Such arrangements provide excess of alignment data and allow for leas-squares alignment of the wafer WR to wafer W.

Post alignment of the receptacles R′, the receptacle wafer WR is bonded to the wafer W. The two wafers W and WR can be permanently joined by soldering, diffusion bonding, or with a thermosetting epoxy that may be cured with UV light (requires that one of the wafers be transparent to UV light) or a thermal temperature cycle. For example, the wafer WR or wafer W is patterned with solder or spin-coated with epoxy.

As in the previous embodiments, similar testing of the devices may be conducted prior to or post dicing of the bonded wafer.

In a further embodiment, instead of using an alignment optical connector to place and attach receptacles to devices on a wafer W, the data optical connector DC (the test optical connector TC) described in the previous embodiments may be used for both receptacle alignment and test/data functions. Referring back to FIGS. 1D and 2D, the pitch p is the distance between two adjacent corresponding rows of alignment features (i.e., alignment bumps in the illustrated embodiments) on the receptacle R and cover plate CP. If the pitch p and distance d between the alignment ports AP and the data optical ports DP are equal, then it is possible to use the same data/test connector for both alignment, test, and data, by indexing the same data/test connector between alignment function and data/test function by a distance p=d. In other words, referring to FIG. 4A, for the data optical connector DC to undertake receptacle alignment function, it can be moved/indexed with respect to the receptacle R by a distance p=d in the direction towards the right of the FIG. 4A. This would shift the light beam from the mirror M to the right, to be directed to the alignment ports AP.

Accordingly, the alignment optical connector may be another data optical connector DC (or test optical connector TC) deployed for aligning the receptacle R to the device body D, wherein positioning the receptacle R comprises demountably attaching the data optical connector DC to the receptacle R at a first index location at which wherein the data connector body DC supports at least an output optical fiber corresponding to the alignment input port AIP of the optical alignment waveguide AWG and an input optical fiber corresponding to the alignment output port AOP of the optical alignment waveguide AWG. After attaching the receptacle R to the device body D in the aligned position, the data optical connector DC is demountably attached to the receptacle R at a second index position, with an offset to the first index position equivalent to the parallel spacing p=d at which the data optical fibers are optically aligned to the data optical ports DP of the optical data optical waveguides DWG in the aligned position of the receptacle R in relation to the optoelectronic device, either for transmission of data optical signals in service, or for transmission of test optical signals to determine optical signal coupling efficiency via the data optical connector.

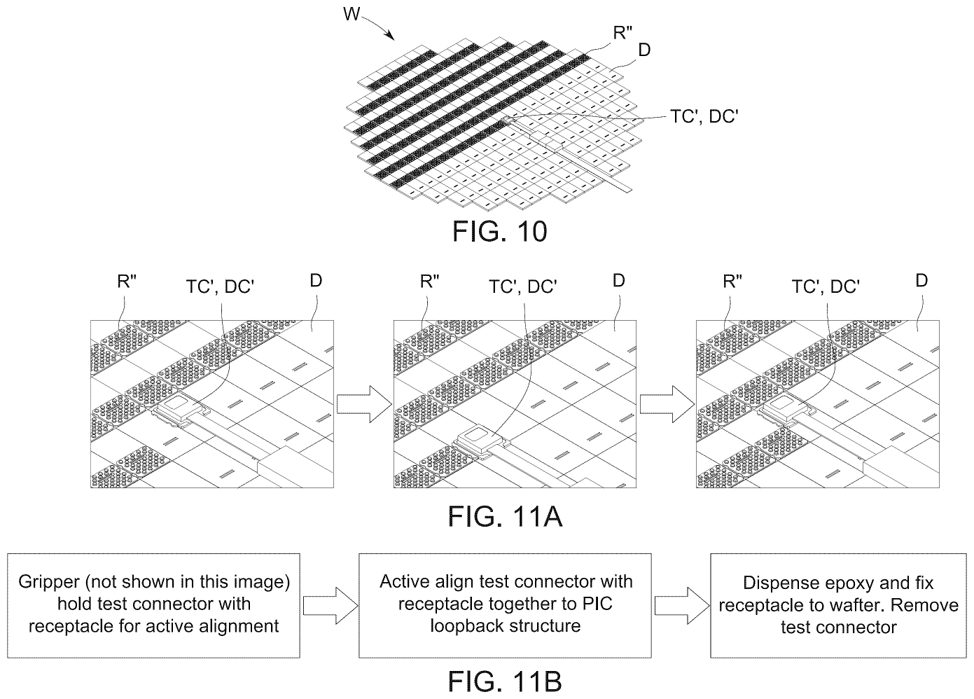

FIG. 10 schematically depicts attachment of receptacles R″ to PIC chips at a wafer level using a test or data optical connector TC′ or DC′, in accordance with another embodiment of the present invention. FIG. 11A illustrates enlarged views of a sequence of attaching a receptacle R″ to a PIC chip at a wafer level, and FIG. 11B illustrates a flow diagram corresponding to the sequence in FIG. 7B, in accordance with another embodiment of the present invention. The flow process is similar to FIG. 7A, except for alignment function, the test optical connector TC′ or data optical connector DC′ is demountably attached to the receptacle R″ at an indexed position from the demountable coupling position for normal demountable coupling for regular data optical connector or test optical connector functions. The distance between indexed demountable coupling positions for receptacle alignment and regular data operation is equivalent to the distance d′ between centerline of two adjacent rows of passive alignment features (e.g., in the illustrated embodiment, between two adjacent rows of isolated alignment bumps BMP) on the receptacle or the cover plate of the connector body, In this embodiment, the parallel spacing between the row of data optical ports DP and alignment optical ports on the device body D needs to match this distance d′, or vice versa.

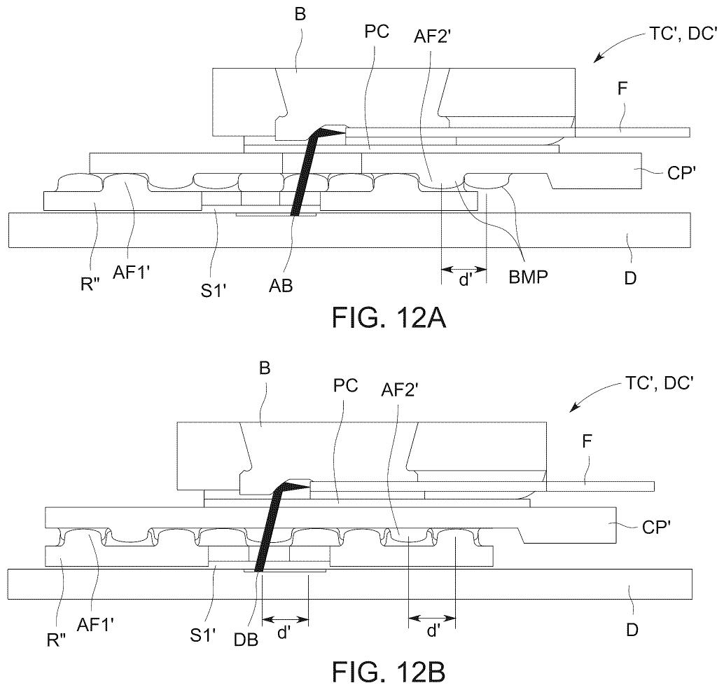

FIG. 12A and FIG. 12B are sectional views of a test/data optical connector TC′/DC′ in a first indexed location with respect to the receptacle for active alignment of the receptacle to the device body, and a second indexed location for testing and active use of the test/data optical connector, in accordance with one embodiment of the present invention. Compared to the earlier embodiments of FIGS. 4A and 4C, this embodiment requires a modified receptacle R″ and a modified cover plate CP′ for the test optical connector TC′ or data optical connector DC′ to be used for receptacle alignment. The receptacle R″ has a planar array of passive alignment features AF1′ and the cover plate CP′ has a matching planar array of passive alignment features AF2′. The passive alignment features AF1′ and AF2′ have similar arrangement as the corresponding passive alignment features AF1 and AF2 in the previous embodiment (i.e., each comprising a matching orderly planar array of alignment bumps BMP). As shown in FIGS. 12A and 12B, the slot S′ in the receptacle R″ is wider than the slot S in FIGS. 4A and 4B, to accommodate the indexed shifting of the position of the alignment optical path AB in FIG. 12A to the data optical path DB in FIG. 12B after the cover plate CP′ is indexed by one adjacent row of bumps BMP by distance d′. Otherwise, the optical bench B for the test optical connector TC′ and the data optical connector DC′ is similar to the optical bench B in the previous embodiment.

It is noted that the sectional view in FIG. 12A and the sectional view in FIG. 12B are taken along different adjacent planes of the receptacle R″, to more clearly illustrate the indexing of the cover plate CP′ by one adjacent row of alignment bumps BMP of the cover plate CP′ (or the receptacle R″) in the longitudinal direction toward the left of the FIG. 12B. The plane of the sectional view in FIG. 12A and the plane of the sectional view in FIG. 12B are laterally spaced by a distance d′ as well. Hence, indexing of the cover plate CP′ between demountable couplings for alignment function and operational data/test function would involve shifting of the cover plate CP′ in two orthogonal directions (i.e., in a first, longitudinal direction to the left of the drawings and in a second, lateral direction orthogonal to the first direction).

Referring to FIGS. 5A and 5B, given the lateral index shift of d′, the row of alignment optical ports AP and the row of data optical ports should be staggered by a spacing d′ to accommodate the lateral shift of the cover plate CP′ for demountable coupling for data regular operation after receptacle alignment using the same test/data optical connector TC′/DC′.

Accordingly, the alignment optical connector may be another data optical connector DC′ (or test optical connector TC′) deployed for aligning the receptacle R″ to the device body D, wherein positioning the receptacle R″ comprises demountably attaching the data optical connector DC′ to the receptacle R″ at a first index location at which wherein the data connector body DC′ supports at least an output optical fiber corresponding to the alignment input port AIP of the optical alignment waveguide AWG and an input optical fiber corresponding to the alignment output port AOP of the optical alignment waveguide AWG. After attaching the receptacle R″ to the device body D in the aligned position, the data optical connector DC′ is demountably attached to the receptacle R″ at a second index position, with an offset to the first index position equivalent to the parallel spacing d′ at which the data optical fibers are optically aligned to the data optical ports DP of the optical data optical waveguides DWG in the aligned position of the receptacle R″ in relation to the optoelectronic device, either for transmission of data optical signals in service, or for transmission of test optical signals to determine optical signal coupling efficiency via the data optical connector.

In another aspect of the present invention, a master tool is provided as a reference datum to correlate related features of the alignment optical connector and the data/test optical connector during assembly of the alignment optical connector and the data/test optical connector, including aligning the second set of passive alignment features in relation to the alignment optical fibers, and aligning the third/fourth set of passive alignment features to the data/test optical fibers.

In accordance with the present invention, the master tool defines the first set of passive alignment features used for calibrating and assembling the cover plate with respect to the optical bench for the alignment optical connectors, test optical connectors, and/or data optical connector described above. The master tool may be in the form of an assembly optoelectronic device having a set of master alignment features matching/complementary to the second set of passive alignment features of the alignment connector body and third/fourth set of passive alignment features of the data/test connector body, which is similar to the first set of passive alignment features of the receptacle (i.e., AF1 or AF1′) and two row of ports analogous to the row of alignment optical ports AP and the row of data optical ports DP as described above. By first demountable coupling the cover plate to the first set of passive alignment features on the master tool, the cover plate is actively aligned to the optical bench, before attaching (e.g., by epoxy) the cover plate to the optical bench. The master tool thereby provides a common reference datum to correlate related features of the alignment optical connector and the data/test optical connector to reduce potential alignment discrepancies between the various connectors.

Accordingly, assembling the cover plate of the alignment connector body to the base of the alignment connector body is conducted by demountably attaching the second set of passive alignment features of the cover plate of the alignment optical connector to the set of master alignment features, positioning the bottom of the base relative to the cover plate by observing the alignment optical signal and securing the cover plate to the bottom of the base. Assembling the cover plate of the data/test connector body to its base is conducted by demountably attaching the third/fourth set of the alignment features of the cover plate of the data/test optical connector to the set of master alignment features and positioning the bottom of the base relative to the cover plate by observing the data/test optical signal and securing the cover plate to the bottom of the base, wherein as between the alignment optical connector and the data/test optical connector, the cover plate is offset by a distance equivalent to the parallel spacing between the first row of data optical ports and the second row of alignment optical ports.

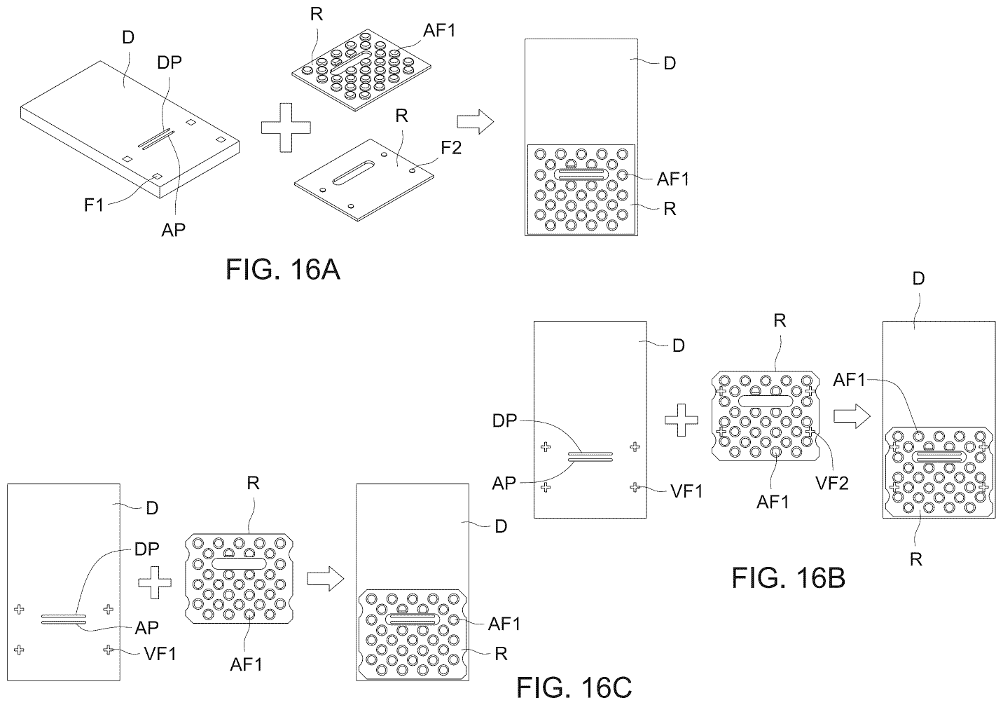

In a further embodiment, passive pre-alignment (i.e., rough alignment) of the receptacle on the device body is implemented by passive alignment prior to deploying the alignment optical connector for precise alignment of the receptacle. FIGS. 16A to 16C illustrate different embodiments of pre-alignment of a receptacle to a device body by passive alignment.

In FIG. 16A, physical fiducial features F1 are provided on the device body D (e.g., at wafer level) which are located with reference to the optical alignment ports AP and data optical ports DP on the device body, and matching physical fiducial features F2 are provided at the bottom surface of the receptacle R which are located with reference to the first set of passive alignment features AF1 on the top surface of the receptacle R. The matching of the fiducial features F1 and F2 can achieve alignment accuracy of a few micrometers. This enables “first-light” for subsequent loopback alignment described above for more accurate active alignment. The gripper can more accurately align the receptacle R to the device body D using the alignment optical connector AC as explained earlier.

In FIG. 16B, visual fiducial marks VF1 are provided on the device body D (e.g., at wafer level) which are aligned to the optical alignment ports AP and data optical ports DP on the device body, and matching visual fiducial features VF2 are provided at the top surface of the receptacle R which are located with reference to the first set of passive alignment features AF1 on the top surface of the receptacle. Using computer vision/imaging, the visual fiducial marks on both the device body D and the receptacle R are aligned. The passive alignment based on the visual fiducial VF1 and VF2 can achieve alignment accuracy of a few micrometers. This enables “first-light” for subsequent loopback alignment described above for more accurate active alignment. The gripper can more accurately align the receptacle R to the device body D using the alignment optical connector AC as explained earlier.

In FIG. 16C, visual fiducial marks VF1 are provided on the device body D (e.g., at wafer level) which are located with reference to the optical alignment ports AP and data optical ports DP on the device body D. Using computer vision/imaging, the first set of passive alignment features AF1 on the receptacle R is analyzed using blob analysis to determine the centroid point of the receptacle R, which is based to passively align to the visual fiducial marks VF1 on the device body D.

Accordingly, passive pre-alignment of the receptacle R to the device body D includes one of the following:
(a) providing fiducial features F1 (e.g., wells) on the top surface of the device body D in a defined relation to the alignment ports and data optical port of the device body D, providing matching/complementary fiducial features F2 (e.g., protrusions) defined on a bottom surface of the receptacle R in a defined relation to the first set of passive alignment features AF1 on the top surface of the receptacle R, and placing the receptacle R on the device body by passively engaging the matching/complementary fiducial features F1 and F2;
(b) providing visual fiducial marks VF1 on the top surface of device body D in a defined relation to the alignment ports AP and data optical port DP of the device body D, providing matching/complementary visual fiducial marks VF2 on the top surface of the receptacle R in a defined relation to the first set of passive alignment features on the top surface of the receptacle R, and placing the receptacle R on the device body by passively aligning the matching/complementary visual fiducial marks VF1 and VF2; or
(c) providing visual fiducial marks VF1 on the top surface of device body D, using compute vision to image the first set of passive alignment features AF1 on the top surface of the receptacle R, compute centroid location of the receptacle R (e.g., using blob analysis which is a computer vision technique that analyzes connected groups of pixels, or blobs, in an image), and passively aligning the receptacle R on the device body D based on the centroid location in predetermined relation to the visual fiducial marks VF1 on the device body.

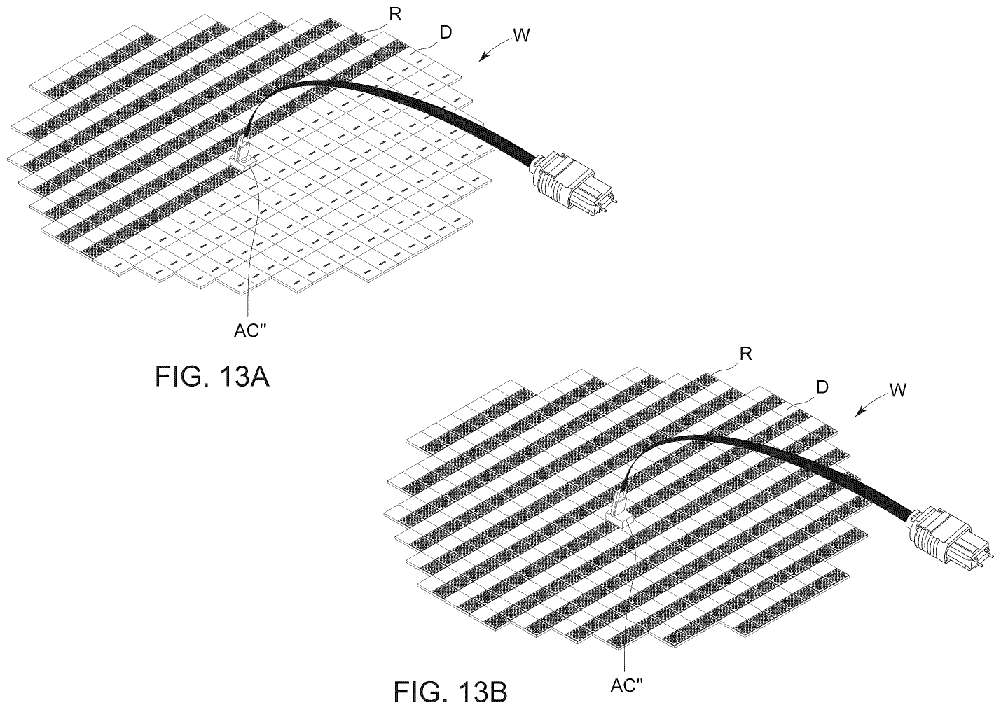

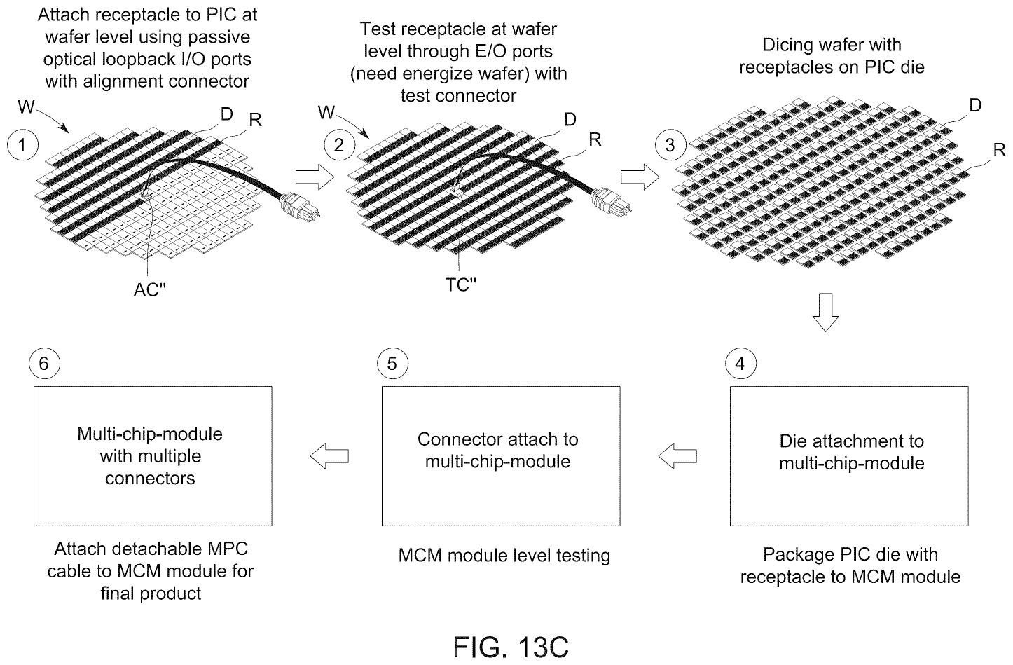

FIGS. 13A to 13C schematically depict attachment of receptacles R to PIC chips/device bodies D at a wafer level using an alignment optical connector AC″ that supports optical fibers F at an angle, followed by wafer level testing using a testing optical connector TC″ that also supports optical fibers F at an angle. Thereafter, the wafer W is diced into individual dies, in accordance with another embodiment of the present invention. The dies could be attached to a multi-chip module.

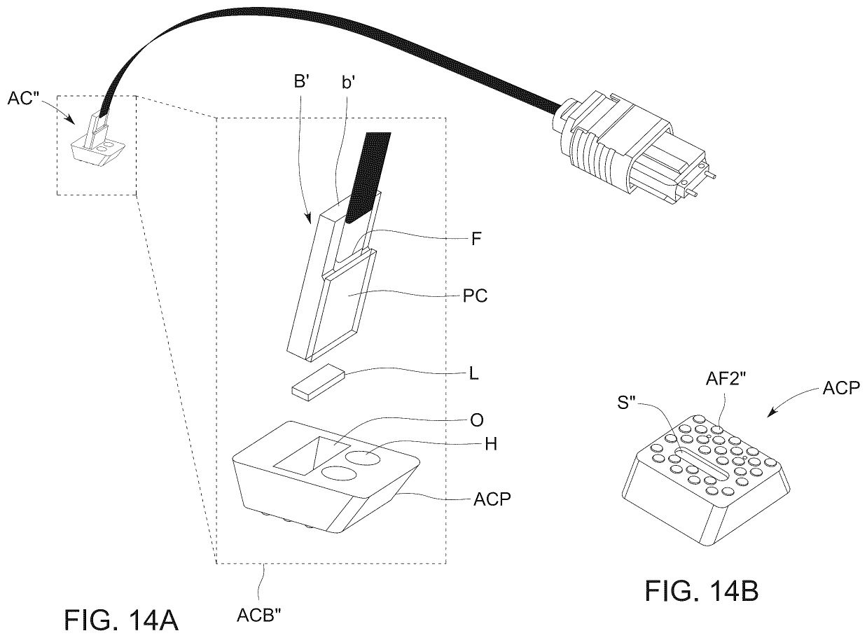

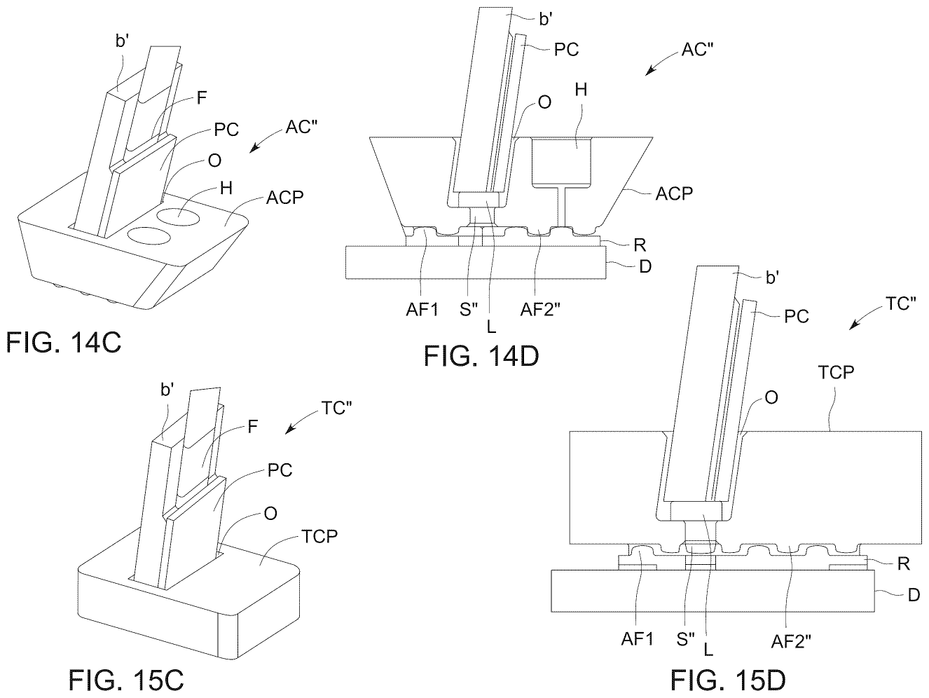

FIGS. 14A to 14D illustrate an alignment optical connector AC″ in accordance with another embodiment. The alignment connector body ACB″ is a unitary body with a bottom surface defined with the second set of passive alignment features AF2″. The alignment connector body ACB″ comprises an optical bench or ferrule B′ without any structured reflective surface, unlike the optical bench B in the earlier embodiments. The optical bench B′ has a base b′ having grooves supporting an array of optical fibers F between the base b′ and glass plate cover PC. A microlens array L is provided at the end face of the array of fibers F to expand/collimate and diverge/focus light beams from and to the optical fibers F. The cover plate ACP of the alignment connector body ACB″ is generally trapezoidal pyramid shaped, with tapered opposite sides. A planar array of alignment features AF2″ is provided on a smaller underside of the cover plate ACP, generally resembling the pattern of the passive alignment features AF2 in FIG. 2D, to match the passive alignment features AF1 on a receptacle R. The cover plate ACP has a rectangular opening O at the larger topside for receiving the optical bench B′. The rectangular opening O terminates at a slot S″ for optical paths to at least the alignment optical ports AP on the device body D. Through holes H are provided to facilitate pin release of the cover plate ACP from the receptacle R upon completion of receptacle alignment operation by a gripper/pick-and-place machine.

Overall, the optical bench B′ inserted into the rectangular opening O supports the optical fibers F at an angle (closer to vertical) to the device body D when the alignment optical connector AC″ is demountably attached to the device body D. The microlens array L may be a silicon microlens array, a glass microlens array, a polymer microlens array or a 3D printed microlens array. The cover plate ACP may be made of tungsten carbide.

The design considerations and advantages of the alignment optical connector AC″ include:
a. Superior material properties of tungsten carbide permit repeated use of the alignment optical connector AC″ for demountable couplings to receptacles for receptacle alignment operations, without deterioration of the passive alignment features,
b. The tungsten carbide cover plate allows for precision machining to produce an accurate reference datum.
c. High quality/pre-tested fiber array attached with microlens array to provide light beam matching the data connector. Entire assembly is actively aligned and attached to the cover plate ACP,
d. Tapered front and back ends (shown in FIG. 14D) facilitate epoxy dispensing and UV light curing for epoxy.
e. Through holes 1 for electing/releasing the alignment optical connector AC″ from a receptacle R on device body D.

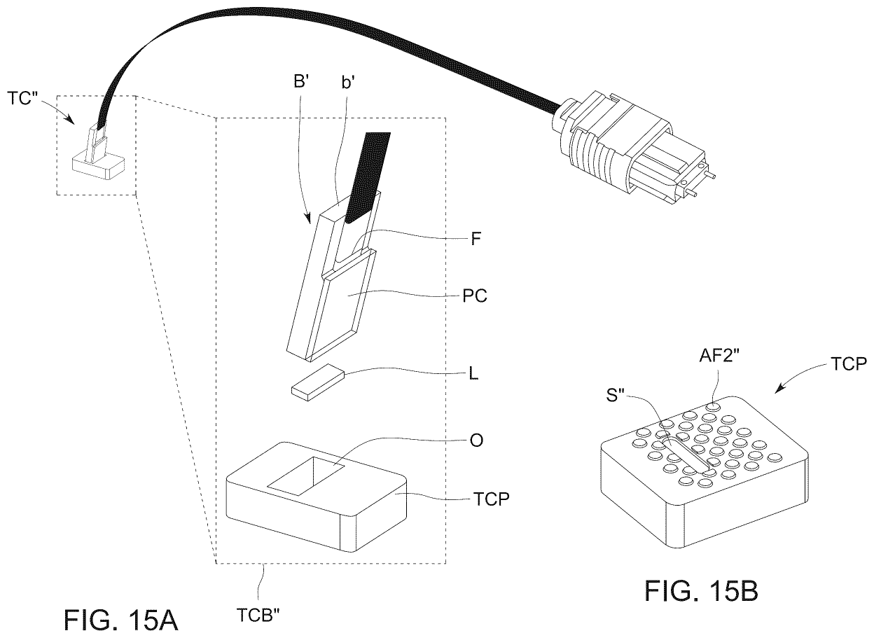

FIGS. 15A to 15D illustrate a test optical connector TC″ that corresponds to the alignment optical connector AC″ in FIGS. 14A to 14D. Like the alignment optical connector AC″, the test connector body TCB″ comprises an optical bench or ferrule B′ similar to the optical bench B′ of the alignment optical connector AC″. The cover plate TCP of the test connector body TCB″ is generally cuboid shaped. A planar array of alignment features AF2″ is provided on the underside of the cover plate TCP, generally resembling the pattern of the passive alignment features AF2 in FIG. 2D, to match the passive alignment features AF1 on a receptacle R. The cover plate TCP has a rectangular opening O at the topside for receiving the optical bench B′. The rectangular opening O terminates at a slot S″ for optical paths to at least the data optical ports DP on the device body D. Through holes H (not shown) may be provided to facilitate pin release of the cover plate TCP from the receptacle R upon completion of receptacle alignment operation by a gripper/pick-and-place machine.

Overall, like the alignment optical connector AC″, the optical bench B′ inserted into the rectangular opening O supports the optical fibers F at an angle (closer to vertical) to the device body D when the test optical connector TC is demountably attached to the device body D. The microlens array L may be a silicon microlens array, a glass microlens array, a polymer microlens array or a 3D printed microlens array. The cover plate TCP may be made of tungsten carbide.

The design considerations and advantages of the test optical connector TC″ include:
a. Superior material properties of tungsten carbide permit repeated use of the alignment optical connector TC″ for demountable couplings to receptacles for testing operations, without deterioration of the passive alignment features.
b. Tie tungsten carbide cover plate allows for precision machining to produce an accurate, reference datum,
c. High quality/pre-tested fiber array attached with microlens array to provide light beam similar to data connector. Entire assembly is actively aligned and attached to the cover plate TCP,
d. More space on front and back side (shown in FIG. 15D) without epoxy dispensing constraint.

The location of the rectangular opening O and slot S″ in the test alignment optical connector TC″ is shifted from the location of the rectangular opening O and slot S″ in the alignment optical connector AC″ by a distance equivalent to the parallel spacing d between the row of alignment optical ports AP and data optical ports DP on the device body D, as shown in FIG. 1C. As noted above, the rectangular opening O and slot S″ can be precisely machined for the alignment optical connector AC″ and the test optical connector TC″, and the optical bench B′ is actively aligned and attached to the cover plate.

Accordingly, the alignment connector body ACB″ supports the alignment input and output optical fibers at an angle to the top surface of the device body D, optically coupling the alignment input and output optical fibers to the alignment optical ports AP including alignment input and output ports AIP and AOP on the device body D, wherein the alignment connector body AC″ comprises a microlens array L to expand the alignment optical signals from the alignment output optical fiber to the alignment input port AIP. In this embodiment, the test connector body TCB″ supports the data input and output optical fibers at an angle to the top surface of the device body D, optically coupling the data optical fibers to the data optical ports DP on the device body D, wherein the test connector body comprises a microlens array L to expand the alignment optical signals from the data optical fibers to the data optical ports DP, whereby the optical path from the data optical fibers are offset with respect to the passive alignment features AF2″ by a distance equivalent to the parallel spacing d as compared to the alignment input and output fibers with respect to the passive alignment features AF2″. The alignment connector body ACB″ is tapered with narrowing towards the second set of passive alignment features AF2″ at the bottom surface.

A data optical connector DC″ may take the same configuration and structure as the test optical connector TC″.

In one embodiment, passive alignment between the receptacle and the alignment optical connector and subsequent data optical connector (and optional test optical connector) may be achieved by passive, kinematic coupling, quasi-kinematic coupling, or elastic-averaging coupling. The passive alignment coupling allows a subsequent data optical connector to be detachably coupled to the device body associated with the optoelectronic device, via the receptacle that has been optically aligned to the device body. The data optical connector can be detached from the receptacle and reattached to the receptacle without compromising optical alignment. Accordingly, the optoelectronic device can be attached to a circuit board and after the circuit board is completely populated, a data optical connector with an optical fiber cable can be mechanically and functionally connected to the optoelectronic device on the circuit board. Consequently, the optical fiber cables are not in the way during the assembly of the circuit board.

Several earlier patent disclosures commonly assigned to the assignee of the present application may be reference for stamp forming the optical bench B.

U.S. Patent Application Publication No. US2015/0355420A1 discloses an optical coupling device in the form of an optical bench for routing optical signals for use in an optical communications module, in particular an optical coupling device in the form of an optical bench, in which defined on a metal base is a structured surface having a surface profile that bends, reflects and/or reshapes an incident light. An alignment structure is defined on the base, configured with a surface feature to facilitate positioning an optical component (e.g., an optical fiber) on the base in optical alignment with the structured surface to allow light to be transmitted along a defined path between the structured surface and the optical component. The structured surface and the alignment structure are integrally defined on the base by stamping a malleable metal material of the base. The alignment structure facilitates passive alignment of the optical component on the base in optical alignment with the structured surface to allow light to be transmitted along a defined path between the structured surface and the optical component.

U.S. Pat. No. 7,343,770 discloses a novel precision stamping system for manufacturing small tolerance parts. Such inventive stamping system can be implemented in various stamping processes to produce the components disclosed herein. These stamping processes involve stamping a bulk material (e.g., a metal blank), to form the final overall geometry and geometry of the surface features at tight (i.e., small) tolerances, including reflective surfaces having a desired geometry in precise alignment with the other defined surface features.

U.S. Patent Application Publication No. US2016/0016218A1 further discloses a composite structure including a base having a main portion and an auxiliary portion of dissimilar metallic materials. The base and the auxiliary portion are shaped by stamping. As the auxiliary portion is stamped, it interlocks with the base, and at the same time forming the desired structured features on the auxiliary portion, such as a structured reflective surface, optical fiber alignment feature, etc. With this approach, relatively less critical structured features can be shaped on the bulk of the base with less effort to maintain a relatively larger tolerance, while the relatively more critical structured features on the auxiliary portion are more precisely shaped with further considerations to define dimensions, geometries and/or finishes at relatively smaller tolerances. The auxiliary portion may include a further composite structure of two dissimilar metallic materials associated with different properties for stamping different structured features. This stamping approach improves on the earlier stamping process in U.S. Pat. No. 7,343,770, in which the bulk material that is subjected to stamping is a homogenous material (e.g., a strip of metal, such as Kovar, aluminum, etc.) The stamping process produces structural features out of the single homogeneous material. Thus, different features would share the properties of the material, which may not be optimized for one or more features. For example, a material that has a property suitable for stamping an alignment feature may not possess a property that is suitable for stamping a reflective surface feature having the best light reflective efficiency to reduce optical signal losses.

The above noted patent publication can be further referenced in connection with forming the optical benches B, and further forming the passive alignment features of metal components disclose herein below.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. An optoelectronic device implementing a passive alignment demountable coupling for a data (or service) optical connector in an optically aligned position, comprising:
a device body (e.g., a housing of the optoelectronic device, an interposer, etc.) associated with the optoelectronic device, comprising:
a first linear array of at least two active data optical ports (e.g., active input/output (I/O) ports for grating couplers) arranged in a first row, corresponding to optical data waveguides communicating active data optical signals between the data optical connector with the optoelectronic device;
a second linear array of at least a pair of alignment optical ports (e.g., grating couplers) including an alignment input port and an alignment output port arranged in a second row parallel to and spaced from the first row of data optical ports by a parallel spacing, wherein the pair of alignment ports correspond to a loopback optical alignment waveguide at a defined location in relation to data optical ports, communicating with alignment optical signals between an alignment optical connector; and
a receptacle comprising a bottom surface attached to a top surface of the device body, and a first set of passive alignment features defined on a planar top surface of the receptacle in a defined reference/relation to the data optical ports and the input and alignment output ports.
